(19) United States
(12) Patent Application Publication
(10) Pub. No.: US 2026/0161348 A1
(43) Pub. Date: Jun. 11, 2026

(54) ELECTRONIC DEVICE AND METHOD AND DEVICE FOR SELECTING CHANNEL BY ELECTRONIC DEVICE

(71) Applicant: Samsung Electronics Co., Ltd., Suwon-si (KR)

(72) Inventors: Kisoo AN, Suwon-si (KR); Junha PARK, Suwon-si (KR); Hyunseob OH, Suwon-si (KR)

(21) Appl. No.: 19/408,851

(22) Filed: Dec. 4, 2025

(30) Foreign Application Priority Data
Dec. 11, 2024 (KR) 10-2024-0184071

(51) Int. Cl. G06F 3/16; H04W 74/00

(52) U.S. Cl. CPC G06F 3/165; H04W 74/002

(57) ABSTRACT

A first electronic device according to various embodiments of the disclosure may perform receiving, from an audio output device performing a wireless audio service by being connected to the first electronic device, a first message including information on a connection state of a channel between the first electronic device and the audio output device, searching for a second electronic device around the first electronic device, based on the information on the connection state of the channel between the first electronic device and the audio output device, requesting the second electronic device to perform channel scanning, obtaining a channel estimation result based on a result of scanning by the second electronic device, and changing the channel between the first electronic device and the audio output device, based on the channel estimation result.

### CROSS-REFERENCE TO RELATED APPLICATION

This application is based on and claims priority under 35 U.S.C. 119 to Korean Patent Application No. 10-2024-0184071, filed on Dec. 11, 2024, in the Korean Intellectual Property Office, the disclosure of which is herein incorporated by reference in its entirety.

### BACKGROUND

### 1. Field

The disclosure relates to an electronic device and a method and a device for selecting a channel by an electronic device.

### 2. Description of Related Art

According to the development of wireless communication technology, electronic devices may communicate with other electronic devices through various wireless communication technologies. Representatively, electronic devices may communicate with other electronic devices through Bluetooth and Wi-Fi. Bluetooth is one of the short-range wireless communication technologies that enable electronic devices to be connected and exchange data or information with each other, and may include Bluetooth legacy (or classic) and Bluetooth low energy (BLE). Bluetooth operates in the 2.4 GHz industry-science-medical (ISM) band and transmits data using frequency hopping.

Frequency hopping is a method of, in order to avoid interference, transmitting data while changing frequencies among many channels using different frequencies. Bluetooth may select channels by using methods such as adaptive frequency hopping (AFH) and a channel selection algorithm (CSA). However, conventional channel selection methods may cause performance degradation by failing to exclude low-quality channels and using same without change.

Wi-Fi has become a key wireless communication technology widely used in homes, offices, and public places. Through Wi-Fi, multiple devices may transmit data wirelessly. However, Wi-Fi network performance may be significantly affected by the usage environment. In particular, channels used in Wi-Fi networks may be affected by interference and channel congestion. A large number of devices sharing the same frequency band or other nearby Wi-Fi networks may cause channel interference, leading to reduced data transmission rates or unstable connections. Therefore, technologies for selecting appropriate Wi-Fi channels and periodically switching to optimal channels are required. Particularly, since changing channels may cause connection interruptions or delays and a periodic scanning process may consume excessive resources, efficient channel scanning and switching technologies are necessary.

Accordingly, a method and a device for efficiently selecting and switching to higher-quality channels are needed.

The above-described information may be provided as related art for the purpose of assisting in understanding the disclosure. None of the above contents make an assertion or decision as to whether any of the above might be applicable as prior art with regard to the disclosure.

The above information is presented as background information only to assist with an understanding of the disclosure. No determination has been made, and no assertion is made, as to whether any of the above might be applicable as prior art with regard to the disclosure.

### SUMMARY

The disclosure provides an electronic device and a method and a device for selecting a channel by an electronic device.

A method performed by a first electronic device according to an embodiment of the disclosure includes receiving, from an audio output device performing a wireless audio service by being connected to the first electronic device, a first message including information on a connection state of a channel between the first electronic device and the audio output device, searching for a second electronic device around the first electronic device, based on the information on the connection state of the channel between the first electronic device and the audio output device, requesting the second electronic device to perform channel scanning, obtaining a channel estimation result based on a result of scanning by the second electronic device, and changing the channel between the first electronic device and the audio output device, based on the channel estimation result.

A method performed by a second electronic device according to an embodiment of the disclosure includes connecting to a first electronic device searching for a surrounding electronic device, negotiating a channel scan condition with the first electronic device, performing channel scanning, calculating a channel score, based on a scan result, and transmitting the channel score to the first electronic device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a block diagram of an electronic device in a network environment according to various embodiments of the disclosure;

FIG. 2 illustrates a diagram depicting an outline of a process of selecting a channel by a first electronic device according to an embodiment of the disclosure;

FIG. 3 illustrates a flowchart of a method of selecting a channel by a first electronic device according to an embodiment of the disclosure;

FIG. 4 illustrates a flowchart relating to an operation of a case where a first electronic device has failed to discover a second electronic device according to an embodiment of the disclosure;

FIG. 5 illustrates a flowchart relating to a method of scanning for a channel by a second electronic device according to an embodiment of the disclosure;

FIG. 6 illustrates a flowchart of a method of performing channel scanning by a second electronic device according to an embodiment of the disclosure;

FIG. 7 illustrates a flowchart depicting messages transmitted and received between a first electronic device and a second electronic device according to an embodiment of the disclosure;

FIG. 8 illustrates a diagram depicting signals exchanged between an audio output device, a first electronic device, a second electronic device, and a third electronic device in a process of selecting a channel by the first electronic device according to an embodiment of the disclosure;

FIG. 9 illustrates a diagram depicting signals exchanged between an audio output device, a first electronic device, a second electronic device, and a third electronic device in a process of selecting a channel by the first electronic device according to an embodiment of the disclosure;

FIG. 10 illustrates example formats of second and third messages according to an embodiment of the disclosure;

FIG. 11 illustrates example formats of fourth and fifth messages according to an embodiment of the disclosure;

FIG. 12 illustrate example formats of sixth and response messages according to an embodiment of the disclosure;

FIG. 13 illustrates a block diagram depicting a configuration of a first electronic device according to an embodiment of the disclosure; and

FIG. 14 illustrates a block diagram depicting a configuration of a second electronic device according to an embodiment of the disclosure.

With regard to the description of the drawings, the same or like reference signs may be used to designate the same or like elements.

### DETAILED DESCRIPTION

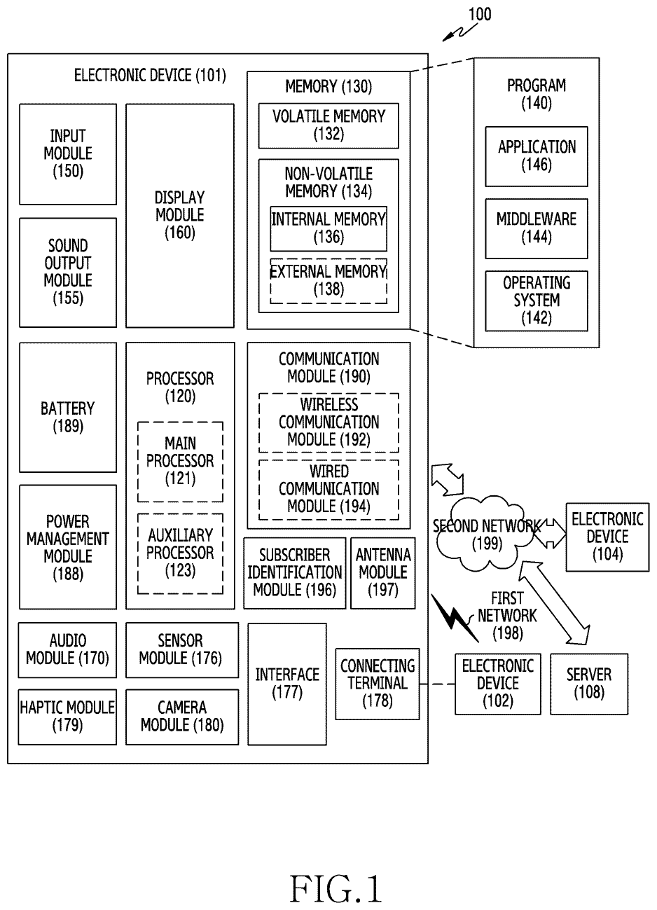

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The technical subjects pursued in the disclosure may not be limited to the above-mentioned technical subjects, and other technical subjects which are not mentioned may be clearly understood from the following descriptions by those skilled in the art to which the disclosure pertains.

Hereinafter, embodiments will be described in detail with reference to the drawings so that those skilled in the art to which the disclosure pertains can easily implement the disclosure. However, the disclosure may be implemented in various forms and is not limited to embodiments set forth herein. In addition, in order to clearly explain the disclosure, parts irrelevant to the explanation are omitted from the drawings, and similar or like parts are provided with similar or like reference signs.

The terms as used herein are expressed using currently used general terms in consideration of the functions mentioned in the disclosure, and may mean various different terms according to intentions of technicians engaged in the art, customs, or emergence of new technologies, and the like. Therefore, the terms as used herein should be interpreted based on the substantial meanings of the terms and the contents throughout the specification, rather than the nominal names of the terms.

Such terms as “a first” and “a second” may be used to describe various elements, but the elements should not be limited by the terms. These terms are used only for the purpose of distinguishing one element from any other element.

In the disclosure, when a certain part is described as being “connected” to another part, this includes not only cases where they are “directly connected” but also cases where they are “electrically connected” or “operatively connected” with another component interposed therebetween. The expression that a certain part “includes” an element means that the part may further include the other element, rather than excluding the other element, unless otherwise stated.

In the disclosure, phrases such as “in an embodiment” appearing in various places do not necessarily refer to the same embodiment.

In the disclosure, communication link management includes operations for providing smooth communication by managing the communication link between a wearable electronic device and an electronic device, based on whether a user is wearing the wearable electronic device. For example, communication link management may include generating, maintaining, releasing, and monitoring of a communication link. However, this is merely an example, and communication link management is not limited thereto and may include various operations such as transmission power control, channel coding and modulation, etc.

Additionally, the connection lines or connection members between the elements illustrated in the drawings merely represent an example of functional connections and/or physical or circuit connections. In an actual device, the connections between elements may be represented through various alternative or additional functional, physical, or circuit connections.

Hereinafter, the disclosure will be described in detail with reference to the accompanying drawings.

FIG. 1 illustrates a block diagram of an electronic device 101 in a network environment 100 according to various embodiments of the disclosure. The electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth®, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore®), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

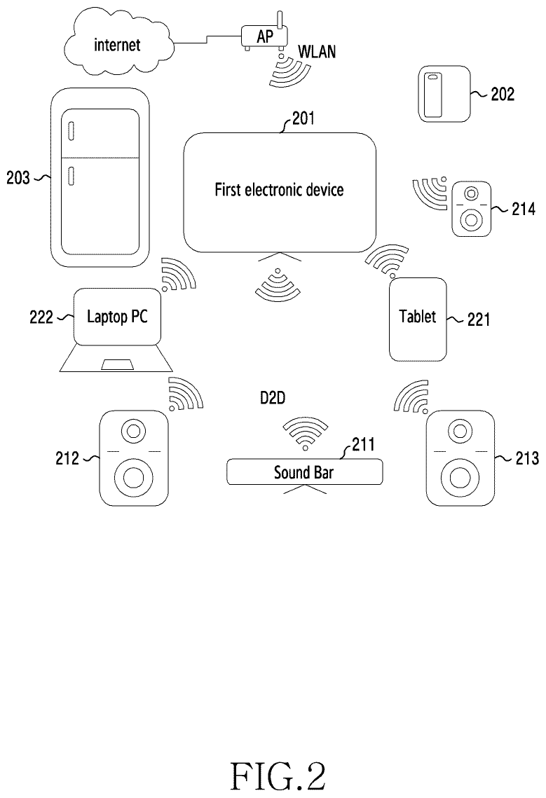

FIG. 2 illustrates a diagram depicting an outline of a process of selecting a channel by a first electronic device 201 according to an embodiment of the disclosure.

The first electronic device 201 may be a master device or a source device providing data (e.g., audio data or multimedia data). For example, the first electronic device 201 may be an electronic device like a TV. For example, the first electronic device 201 may be an electronic device like a smartphone. The first electronic device 201 according to the disclosure may be the electronic device 101 in FIG. 1.

Audio output device #1 211, audio output device #2 212, audio output device #3 213, and/or audio output device #4 214 may be slave devices or sink devices capable of receiving data from the first electronic device 201 and processing or outputting the received data.

External electronic device #1 221 and external electronic device #2 222 may perform wireless communication, thereby affecting a connection state of a channel between the first electronic device 201 and an audio output device. For example, external electronic device #1 221 may be an electronic device like a tablet PC. For example, external electronic device #2 222 may be an electronic device like a laptop.

The first electronic device 201 and audio output device #1 211, the first electronic device 201 and audio output device #2 212, the first electronic device 201 and audio output device #3 213, or the first electronic device 201 and audio output device #4 214 may be connected to each other and perform data transmission and reception based on a wireless communication technology (e.g., Bluetooth legacy (or classic) or a BLE communication technology).

The first electronic device 201 and audio output device #1 211, the first electronic device 201 and audio output device #2 212, the first electronic device 201 and audio output device #3 213, or the first electronic device 201 and audio output device #4 214 may be concurrently connected and perform data transmission and reception. For example, the first electronic device 201 may be concurrently connected to audio output device #1 211, audio output device #2 212, audio output device #3 213, and audio output device #4 214 so as to provide an audio output service.

At least two of audio output device #1 211, audio output device #2 212, audio output device #3 213, or audio output device #4 214 may be devices included in a single set. For example, the devices included in a single set may be devices that are connected through separate communication links, respectively, to provide a relevant function so as to provide a single integrated service (e.g., stereo sound output or 5.1 channel sound output). For example, audio output device #1 211, audio output device #2 212, audio output device #3 213, and audio output device #4 214 may be audio devices operating as a single set. In FIG. 2, four audio output devices are illustrated, but the number of audio output devices according to the disclosure is not limited to 4.

A second electronic device 202 or a third electronic device 203 may be an electronic device around the first electronic device 201, which is capable of performing wireless channel scanning. For example, the second electronic device 202 may be an electronic device like a smartphone. For example, the third electronic device 203 may be an electronic device like a smart refrigerator. The second electronic device 202 or the third electronic device 203 may be an electronic device positioned at a place where a wireless connection with the first electronic device 201 can be established. For example, the second electronic device 202 or the third electronic device 203 may have a communication module having superior performance compared to the first electronic device 201. The second electronic device 202 or the third electronic device 203 may have more antennas or a higher-performance processor compared to the first electronic device 201 so as to smoothly perform channel scanning. However, the second electronic device 202 or the third electronic device 203 is not limited to the example according to the disclosure, and the second electronic device 202 or the third electronic device 203 may also include another electronic device connected to the first electronic device 201 to perform channel scanning, which is not proposed as an example.

The first electronic device 201 and the second electronic device 202 or the first electronic device 201 and the third electronic device 203 may proceed with data transmission and reception by being connected to each other based on a wireless communication technology. For example, the first electronic device 201 and the second electronic device 202 or the first electronic device 201 and the third electronic device 203 may perform data transmission and reception by being connected to each other, based on a BLE communication technology. For example, the first electronic device 201 and the second electronic device 202 or the first electronic device 201 and the third electronic device 203 may perform data transmission and reception by being connected to each other through a server.

A connection state of a channel between the first electronic device 201 and an audio output device may become not good or poor (e.g., below a predefined threshold). In an embodiment, another electronic device may interfere with a channel between the first electronic device 201 and the audio output device. For example, external electronic device #1 221 or external electronic device #2 222 may use a channel overlapping with a channel between the first electronic device 201 and the audio output device, thereby affecting a channel state. In an embodiment, a connection state of a channel between the first electronic device 201 and the audio output device may become not good due to path loss. For example, a connection state of a channel may be affected due to an obstacle between the first electronic device 201 and the audio output device. A connection state of a channel may be affected due to signal attenuation according to the distance between the first electronic device 201 and the audio output device. In an embodiment, a connection state of a channel between the first electronic device 201 and the audio output device may be affected due to an environment condition. For example, the humidity or temperature around the first electronic device 201 may have an influence. For example, a channel state may be affected due to the Doppler effect caused by the movement of the first electronic device 201 and the audio output device.

In an embodiment, the first electronic device 201 may receive, from the audio output devices 211, 212, 213, and 214, a first message including information on a connection state of a channel between the first electronic device 201 and the audio output devices 211, 212, 213, and 214. The first electronic device 201 may determine whether a connection state of a channel between the first electronic device 201 and an audio output device is good based on the received first message.

According to an embodiment, when it is determined that a connection state of a channel between the first electronic device 201 and an audio output device is not good, the first electronic device 201 may scan for a channel by using an external electronic device. While performing an audio service with the audio output device, the first electronic device 201 may scan for a channel usable between the first electronic device 201 and the audio output device by using the external electronic device. The first electronic device 201 may scan for a channel by using the external electronic device so as to continue the audio service without interruptions. That is, the first electronic device 201 may scan for a channel by using the external electronic device without directly scanning for a channel so as to smoothly perform the audio service. For example, the first electronic device 201 may scan for a channel by using at least one of the second electronic device 202 or the third electronic device 203.

According to an embodiment, the first electronic device 201 may obtain a channel scan result from an external electronic device. For example, the first electronic device 201 may obtain a channel scan result from at least one of the second electronic device 202 or the third electronic device 203. For example, the channel scan result may include a channel score calculated by the second electronic device 202 or the third electronic device 203.

According to an embodiment, the first electronic device 201 may select an optimal channel by using an obtained channel scan result. For example, the first electronic device 201 may select an optimal channel, based on a channel score included in a channel scan result received from at least one of the second electronic device 202 or the third electronic device 203. For example, when respective channel scan results are received from the second electronic device 202 and the third electronic device 203, the first electronic device 201 may select an optimal channel by combining the respective channel scan results.

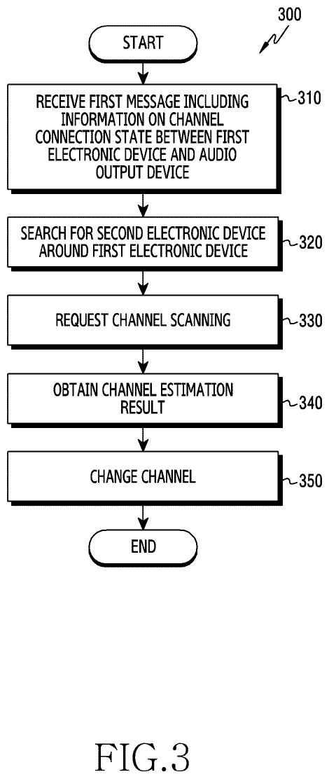

FIG. 3 illustrates a flowchart 300 of a method of selecting a channel by a first electronic device according to an embodiment of the disclosure.

As illustrated in FIG. 3, in operation 310, the first electronic device 201 may receive a first message including information on a connection state of a channel between the first electronic device 201 and an audio output device.

According to an embodiment, the channel between the first electronic device 201 and the audio output device may include a wireless channel according to a frequency band of Wi-Fi. For example, the channel between the first electronic device 201 and the audio output device may include a wireless channel in a frequency band of Wi-Fi being a 2.4 GHz band, a 5 GHz band, or a 6 GHz band. However, the wireless channel according to the disclosure is not limited to the above example and, for example, the channel between the first electronic device 201 and the audio output device may include a channel according to a frequency band of Bluetooth.

The first electronic device 201 may provide an audio service through a wireless connection with the audio output device. For example, the first electronic device 201 may transmit audio data to the audio output device. The audio output device may output the audio data received from the first electronic device 201 to provide the audio service.

According to an embodiment, the first electronic device 201 may receive, from the audio output device, a first message including information on a connection state of a channel between the first electronic device 201 and the audio output device. More specifically, the first message may include a report relating to a measurement value obtained by the audio output device by measuring a state of the channel between the first electronic device 201 and the audio output device. For example, the first message may include a measurement report relating to the channel between the first electronic device 201 and the audio output device, the measurement report created by the audio output device.

According to an embodiment, the first electronic device 201 may determine a channel connection state between the first electronic device 201 and the audio output device. The first electronic device 201 may determine, through the first message received from the audio output device, whether a channel connection state is good. The first message may include a measurement report obtained by the audio output device by measuring a channel state. The first electronic device 201 may determine a channel connection state between the first electronic device 201 and the audio output device, based on the measurement report. For example, when use by external electronic devices increases in the channel between the first electronic device 201 and the audio output device, interference occurs in the channel and thus the audio service may not be smooth and, in this case, the first electronic device 201 may identify that the channel connection state is not good. The first electronic device 201 may determine that interference has occurred in the channel. When the connection state is not good, the first electronic device 201 may determine that a low quality service has occurred.

According to an embodiment, the first electronic device 201 may receive a first message including information on a connection state of a channel between the first electronic device and the audio output device, and determine that the connection state is not good. The first electronic device 201 may transmit data to the audio output device and receive the first message from the audio output device in response to the transmitted data. The first electronic device 201 may determine that the connection state is not good, through the first message received from the audio output device in response to the data. For example, the first electronic device 201 may identify the connection state based on a time taken to transmit the data to the audio output device and receive the first message. For example, the first electronic device 201 may determine the channel connection state by comparing the information included in the first message with information when the channel state is good. However, a method of identifying the channel connection state by the first electronic device 201 is not limited thereto.

According to an embodiment, the first electronic device 201 may receive a first message including information on a connection state of a channel between the first electronic device and the audio output device and, when it is determined, based on the first message, that the channel connection state between the first electronic device 201 and the audio output device is good, the first electronic device 201 may not change the channel and the first electronic device 201 may perform operation 310.

In operation 320, the first electronic device 201 may search for a second electronic device 202 around the first electronic device 201. More specifically, the first electronic device 201 may search for the second electronic device 202 around the first electronic device 201, based on the information on the connection state of the channel between the first electronic device 201 and the audio output device.

According to an embodiment, when it is determined that the channel connection state between the first electronic device 201 and the audio output device is not good, the first electronic device 201 may perform operation 320. Even when the channel connection state between the first electronic device 201 and the audio output device is not good, the first electronic device 201 is to provide the audio service, and thus the first electronic device 201 performs an operation of searching for the second electronic device 202 that is to perform channel scanning on behalf of the first electronic device, thereby without having to directly perform channel scanning. If the second electronic device 202 positioned around the first electronic device 201 performs a channel scan operation instead of the first electronic device 201, the first electronic device 201 may change the channel with the audio output device to a good channel without disconnecting the audio service being provided.

According to an embodiment, the first electronic device 201 may search for the second electronic device 202 around the first electronic device 201 and then establish a wireless connection with the second electronic device 202.

According to an embodiment, the first electronic device 201 may search for the second electronic device 202 and establish a wireless connection therewith through the BLE communication. The first electronic device 201 may broadcast an advertising packet. The first electronic device 201 may establish a wireless connection with the second electronic device 202 having received the advertising packet. More specifically, the first electronic device 201 may broadcast a second message including information related to a channel scan request through a BLE advertising packet. The first electronic device 201 may establish a wireless connection with the second electronic device 202 based on the BLE advertising packet.

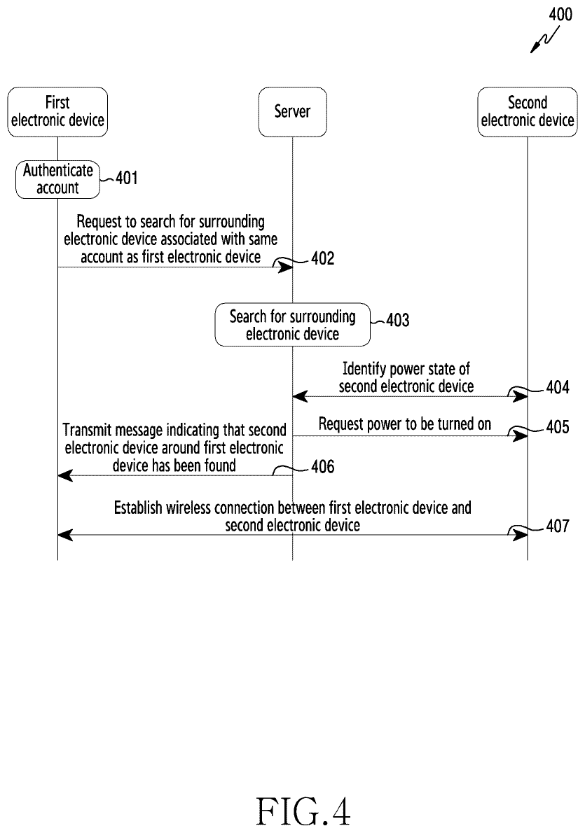

According to an embodiment, the first electronic device 201 may search for the second electronic device 202 and establish a wireless connection therewith through a server. For example, the first electronic device 201 may transmit, to the server, a request to search for the second electronic device 202 around the first electronic device 201. The server may relay a connection between the second electronic device 202 and the first electronic device 201 according to the request of the first electronic device 201. The first electronic device 201 may indirectly establish a wireless connection with the second electronic device 202 through the server or may configure a connection protocol by means of the server to directly establish a wireless connection with the second electronic device 202. The description of searching for the second electronic device 202 through the server will be described with reference to FIG. 4 later.

According to an embodiment, when the second electronic device 202 around the first electronic device 201 is searched for, a second message including information related to a channel scan request may be transmitted to the second electronic device 202. The second message may include information indicating that a scan operation of the second electronic device 202 is to be made. For example, the second message may include information that requests an electronic device around the first electronic device 201 to scan for a channel to be used between the first electronic device 201 and the audio output device instead of the first electronic device 201.

According to an embodiment, the second message may include information relating to whether there is a negotiation between the first electronic device 201 and the second electronic device 202 when channel scanning is performed. The second message may include information indicating that a channel negotiation with the first electronic device 201 is to be made when the second electronic device 202 performs channel scanning. For example, the second message may include information indicating that the second electronic device 202 will configure a condition of channel scanning by negotiating, with the first electronic device 201, a detailed condition for performing channel scanning.

According to an embodiment, the second message may include information relating to a minimum Wi-Fi class utilized for channel scanning by the second electronic device 202. The information may be information related to a Wi-Fi class supported by the first electronic device 201. For example, even though there is a channel having a good channel state, if the channel is not supported by the first electronic device 201, the first electronic device 201 is not able to use the channel. Therefore, information relating to a Wi-Fi class is included in the second message so that a supported Wi-Fi class may be adjusted.

According to an embodiment, the first electronic device 201 may receive, from the second electronic device 202 wirelessly connected thereto, a third message including information indicating whether the second electronic device 202 is able to perform channel scanning. The first electronic device 201 may receive, from the second electronic device 202 in response to the second message having been transmitted to the second electronic device 202, a third message including information indicating whether the second electronic device 202 is able to perform channel scanning. The third message may include information relating to a Wi-Fi class supported by the second electronic device 202. For example, the third message may include information indicating that the second electronic device 202 is able to perform a scan operation in Wi-Fi class 4 when performing channel scanning.

In operation 330, the first electronic device 201 may request the second electronic device 202 to perform channel scanning.

According to an embodiment, the first electronic device 201 may transmit a fourth message requesting channel scanning to the second electronic device 202. The fourth message may include information relating to a condition requested by the first electronic device 201 when the second electronic device 202 scans for a channel. The fourth message may include at least one of information on a channel preferred by the first electronic device 201, information on a band preferred by the first electronic device 201, weight information utilized for channel score calculation, or information relating to whether there is a negotiation between the first electronic device 201 and the second electronic device 202 at the time of the channel scanning.

According to an embodiment, the first electronic device 201 may receive, from the second electronic device 202, a fifth message including information relating to whether the second electronic device 202 is to accept a condition requested by the first electronic device 201. The fifth message may include at least one of information on a band supported by the second electronic device 202, information on a channel supported by the second electronic device 202, or information indicating whether to accept a condition requested by the first electronic device 201. For example, the first electronic device 201 may receive, from the second electronic device 202, a fifth message including information accepting a channel scan condition. The first electronic device 201 may also receive, from the second electronic device 202, a fifth message including information rejecting a channel scan condition.

According to an embodiment, the first electronic device 201 may negotiate a channel scan condition with the second electronic device 202. For example, when the second electronic device 202 rejects the channel scan condition, the first electronic device 201 may transmit a fourth message including another channel scan condition to the second electronic device 202. Thereafter, when the second electronic device 202 accepts the channel scan condition in response to the fourth message including the other channel scan condition, a negotiation of the channel scan condition is established and the second electronic device 202 may perform channel scanning.

According to an embodiment, when it is determined that there is no second electronic device 202 around the first electronic device 201, the first electronic device 201 may request channel scanning by using one audio output device among multiple audio output devices. For example, the first electronic device 201 may request channel scanning by using one audio output device among multiple audio output devices providing the audio service by being wirelessly connected to the first electronic device 201. The audio output device having been requested by the first electronic device 201 to perform channel scanning may perform channel scanning and transmit a channel estimation result to the first electronic device 201.

In operation 340, the first electronic device 201 may obtain a channel estimation result from the second electronic device 202. More specifically, the first electronic device 201 may obtain a channel estimation result based on a result of scanning by the second electronic device 202.

According to an embodiment, the first electronic device 201 may receive a sixth message including information on a result of scanning for a channel by the second electronic device 202. The sixth message may include a channel score obtained based on a channel scan result by the second electronic device 202. Furthermore, the sixth message may further include feature information of the second electronic device 202 including a Wi-Fi version of the second electronic device 202 or the number of antennas of the second electronic device 202. The sixth message may include an identification (ID) of the second electronic device 202.

According to an embodiment, the first electronic device 201 may receive a seventh message including information on a result of scanning for a channel by the third electronic device 203. That is, the first electronic device 201 may receive a sixth message through the second electronic device 202 around the first electronic device 201, and receive a seventh message through the third electronic device 203 around the first electronic device 201. The seventh message may be received from the third electronic device 203 around the first electronic device 201 and include at least one of a channel score obtained by the third electronic device 203 or feature information of the third electronic device 203.

According to an embodiment, the second electronic device 202 may calculate a channel score, based on a result of scanning for a channel. The channel score is calculated based on the weight information by using information received by the second electronic device 202 from an access point (AP) at the time of the channel scanning. The second electronic device 202 may obtain basic service set (BSS) load information, response time information, response rate information, and radio measurement information through channel scanning. The second electronic device 202 may calculate a channel score by applying a BSS load weight and an estimation weight to the obtained information. The second electronic device 202 may calculate a channel score by assigning a primary weight, based on a result of scanning for a channel. The above information and a method of calculating the channel score will be described later.

In operation 350, the first electronic device 201 may change the channel. More specifically, the first electronic device 201 may change the channel between the first electronic device 201 and the audio output device based on the channel estimation result.

According to an embodiment, the first electronic device 201 may select an optimal channel, based on a channel estimation result, and change the channel between the first electronic device 201 and the audio output device to an optimal channel. The first electronic device 201 may select an optimal channel, based on the channel score and the feature information of the second electronic device 202 received from the second electronic device 202. Accordingly, the first electronic device 201 may switch from the poor channel between the first electronic device 201 and the audio output device to the optimal channel so as to provide a smooth audio service. In addition, the first electronic device 201 may switch to the optimal channel without interrupting the audio service, thereby maximizing the efficiency of the audio service between the first electronic device 201 and the audio output device.

According to an embodiment, the first electronic device 201 may select an optimal channel, based on the channel estimation result. For example, the first electronic device 201 may select an optimal channel based on at least one of the channel score included in the sixth message received from the second electronic device 202 or feature information of surrounding electronic devices. For example, when the first electronic device 201 receives channel scores from the second electronic device 202 and the third electronic device 203, the first electronic device 201 may select an optimal channel by assigning weights to the channel scores based on feature information of the second electronic device 202 and feature information of the third electronic device 203. The first electronic device 201 may select an optimal channel by assigning a secondary weight to a received channel score.

According to an embodiment, the first electronic device 201 may select an optimal channel based on channel estimation results obtained from multiple surrounding electronic devices. Specifically, the first electronic device 201 may select an optimal channel, based on the sixth message received from the second electronic device 202 and the seventh message received from the third electronic device 203. The first electronic device 201 may select an optimal channel, based on at least one of the channel score obtained by the second electronic device 202, the feature information of the second electronic device 202, the channel score obtained by the third electronic device 203, or the feature information of the third electronic device 203.

According to an embodiment, the first electronic device 201 may select an optimal channel by assigning a secondary weight to a channel score. For example, the first electronic device 201 may obtain a channel score included in the sixth message received from the second electronic device 202, and obtain a channel score included in the seventh message received from the third electronic device 203. The first electronic device 201 may calculate a channel score by assigning a weight to the channel score included in the sixth message by using the feature information of the second electronic device 202, and may calculate a channel score by assigning a weight to the channel score included in the seventh message by using the feature information of the third electronic device 203. For example, feature information of a surrounding electronic device may include the number of antennas and Wi-Fi version information. Based on the feature information of a surrounding electronic device having superior performance, a high weight may be assigned. For example, if the second electronic device 202 has more antennas or higher performance compared to the third electronic device 203, the first electronic device 201 may perform calculation by assigning a higher weight to the channel score included in the sixth message. The first electronic device 201 may perform calculation by assigning a lower weight to the channel score included in the seventh message. The first electronic device 201 may assign higher reliability to a channel obtained through scanning by the second electronic device 202 having superior performance, and calculate a channel score according to a second weight so as to select an optimal channel.

According to an embodiment, the first electronic device 201 may receive channel scores from multiple surrounding electronic devices to select an optimal channel, thereby removing a shadow area (a hidden node). The first electronic device 201 may request multiple surrounding devices to perform channel scanning and then receive channel scores calculated by the multiple surrounding devices after scanning channels. The first electronic device 201 may select an optimal channel based on the received channel scores. Accordingly, multiple electronic devices perform channel scanning, thereby performing overlapped channel scanning so as to improve reliability on channel scores and scan reports. In addition, the first electronic device 201 may select an optimal channel by using channel scores and scan reports obtained by scanning channels by multiple electronic devices, thereby performing channel scanning for all areas without shadow areas.

According to an embodiment, the first electronic device 201 may change the channel between the first electronic device 201 and the audio output device. For example, the first electronic device 201 may change the channel based on the channel score received from the second electronic device 202. The first electronic device 201 may select an optimal channel, based on the channel score received from the second electronic device 202, so as to change the channel. The first electronic device 201 may change the existing channel between the first electronic device 201 and the audio output device to the selected optimal channel.

According to the disclosure, the audio service may be interrupted when the first electronic device 201 directly performs channel scanning and searches for an optimal channel. Therefore, the first electronic device 201 may select an optimal channel, based on channel scores obtained by performing channel scanning through at least one surrounding electronic device, so as to establish a wireless connection with the audio output device. Therefore, even while providing the audio service with the audio output device, the first electronic device 201 may search for a good channel and switch to the good channel.

FIG. 4 illustrates a flowchart 400 relating to an operation of a case where a first electronic device 201 has failed to discover a second electronic device 202 according to an embodiment of the disclosure.

In the operation 320 in FIG. 3 above, there is a case where the first electronic device 201 has failed to discover the second electronic device 202. The flowchart 400 is a signal flow diagram relating to an operation for discovering the second electronic device 202 through a server in such case. In an embodiment, the operations of FIG. 4 may correspond to a part of the operation 320 in FIG. 3.

According to an embodiment, in operation 401, the first electronic device 201 may authenticate an account in a cloud through a server. For example, the first electronic device 201 may log in to the server through a user account.

According to an embodiment, before performing the operation 401, the first electronic device 201 may determine whether the second electronic device 202 has been discovered through Bluetooth (e.g., BLE) communication. The first electronic device 201 may determine whether the second electronic device 202 has been discovered through Bluetooth communication within a predetermined time. For example, when the first electronic device 201 has failed to establish a wireless connection with the second electronic device 202 therearound for a threshold time after broadcasting a BLE advertising packet, the first electronic device 201 may determine that discovering the second electronic device 202 has failed.

According to an embodiment, before performing the operation 401, the first electronic device 201 may determine whether the second electronic device 202 has been discovered within a threshold number of times. Specifically, the first electronic device 201 may broadcast a BLE advertising packet to be connected to the second electronic device 202 through Bluetooth wireless communication. The first electronic device 201 may broadcast a BLE advertising packet a threshold number of times, and the second electronic device 202 may transmit a response message in response to the BLE advertising packet within the threshold number of times. In this case, the first electronic device 201 may determine that the second electronic device 202 has been discovered. However, even when the first electronic device 201 has broadcast a BLE advertising packet the threshold number of times, the first electronic device may fail to receive a response message from the second electronic device 202. In this case, the first electronic device 201 may determine that discovering the second electronic device 202 has failed.

According to an embodiment, when the first electronic device 201 has failed to establish a BLE connection with the second electronic device 202, the first electronic device 201 may perform the operation 401 in FIG. 4.

In operation 402, the first electronic device 201 may transmit, to the server, a request to search for an electronic device around the first electronic device 201 linked to the same account as the first electronic device 201.

According to an embodiment, the first electronic device 201 may transmit, to the server, a request to search for an electronic device which is linked to the account of the first electronic device 201 and is positioned around the first electronic device 201. For example, the first electronic device 201 may, in order to scan for a channel by using a surrounding electronic device, transmit a request to search for another electronic device linked to the account of the same user as the first electronic device 201.

In operation 403, the server may search for a surrounding electronic device.

According to an embodiment, the server may search for another electronic device registered in the account of the first electronic device 201. The server may search for the second electronic device 202 registered in the account of the first electronic device 201 and positioned around the first electronic device 201 according to a search request of the first electronic device 201. For example, the server may search for another electronic device registered in the same space as the first electronic device 201.

According to an embodiment, the server may find the second electronic device 202 according to searching for an electronic device around the first electronic device 201. The second electronic device 202 found by the server may be an electronic device linked to the same account as the first electronic device 201.

In operation 404, the server may identify a power state of the second electronic device 202.

According to an embodiment, the server may identify a power state of the second electronic device 202 linked to the same account as the first electronic device 201. The server may identify whether the power state of the second electronic device 202 linked to the same account as the first electronic device 201 is ‘on’ or ‘off’. A case where the power state of the second electronic device 202 is ‘on’ may include a state where a communication module and another module of the second electronic device 202 are turned on. A case where the power state of the second electronic device 202 is ‘off’ may include a state where only the communication module of the second electronic device 202 is turned on.

In operation 405, the server may request to switch the power state of the second electronic device 202 to ‘on’.

In an embodiment, when the power state of the second electronic device 202 is ‘off,’ the server may perform the operation 405. When the power state of the second electronic device 202 is ‘on,’ the operation 405 may be omitted.

According to an embodiment, when the power state of the second electronic device 202 is ‘off,’ the server may switch the power state of the second electronic device 202 to ‘on.’ In an embodiment, even when the power state of the second electronic device 202 is ‘off,’ the server may transmit and receive a signal and/or a message through the communication module of the second electronic device 202. The server may transmit and receive a signal and/or a message for switching the power state of the second electronic device 202 to ‘on,’ to and from the second electronic device 202.

In operation 406, the server may transmit, to the first electronic device 201, a message indicating that the second electronic device 202 around the first electronic device 201 has been found.

In an embodiment, when the power state of the second electronic device 202 is ‘on,’ the server may transmit, to the first electronic device 201, a message indicating that the second electronic device 202 has been found. In an embodiment, when the power state of the second electronic device 202 is switched from ‘off’ to ‘on,’ the server may transmit, to the first electronic device 201, a message indicating that the second electronic device 202 exists around the first electronic device 201.

In operation 407, the first electronic device 201 and the second electronic device 202 may establish a wireless connection.

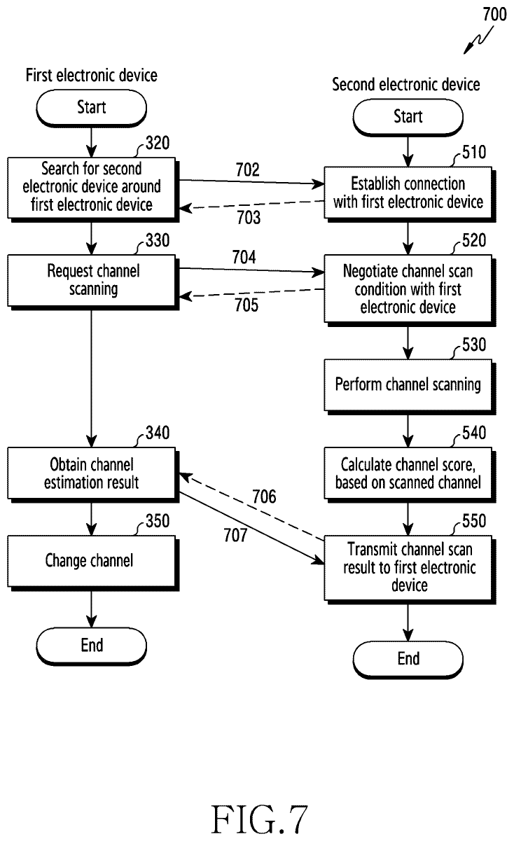

According to an embodiment, when the second electronic device 202 exists, the first electronic device 201 may establish a wireless connection with the second electronic device 202 and transmit, to the second electronic device 202, a second message including information related to a channel scan request. The information related to the channel scan request may include information that inquires whether the second electronic device 202 is able to perform channel scanning. As a response for the second message, the first electronic device 201 may receive, from the second electronic device 202, a third message including information relating to whether the second electronic device 202 is able to perform channel scanning. The above second message and third message will be described with reference to FIG. 7 later.

According to an embodiment, the first electronic device 201 may search for the second electronic device 202 through the server and directly establish a connection with the second electronic device 202. For example, the first electronic device 201 may establish a wireless connection with the second electronic device 202, the power state of which has been switched from ‘off’ to ‘on’ through the server. For example, the first electronic device 201 may configure a connection protocol by means of the server to directly establish a wireless connection with the second electronic device 202.

Although not illustrated in FIG. 4, according to an embodiment, the first electronic device 201 may communicate with the second electronic device 202 through the server. The first electronic device 201 may transmit a message to the second electronic device 202 through the server and receive a message from the second electronic device 202 through the server. That is, the server may perform relaying operations so that the first electronic device 201 and the second electronic device 202 may transmit and receive a message from each other via the server.

In addition, after the first electronic device 201 obtains a channel estimation result, the server may switch the power state of the second electronic device 202 from ‘on’ to ‘off.’ For example, when the first electronic device 201 has found the second electronic device 202 linked to the account through the server and the power state of the second electronic device 202 has been switched from ‘off’ to ‘on,’ the server may switch the power state of the second electronic device 202 from ‘on’ to ‘off’ after the first electronic device 201 obtains a channel estimation result from the second electronic device 202.

In an embodiment, the operations of FIG. 4 have been illustrated as separate operations, but may be performed in parallel or simultaneously.

In an embodiment, after the operations of FIG. 4, the first electronic device 201 may perform the operation 330 of FIG. 3.

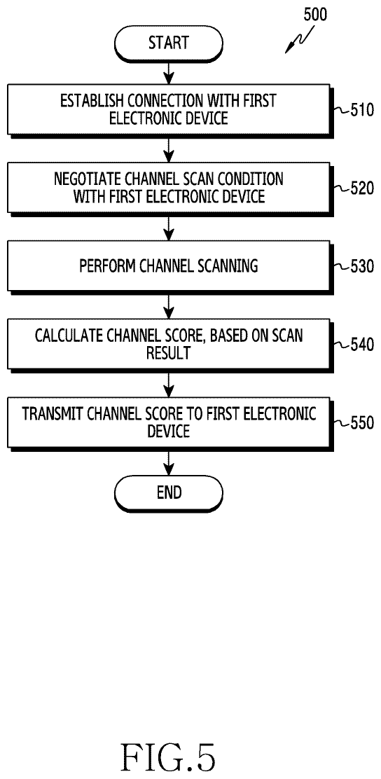

FIG. 5 illustrates a flowchart 500 relating to a method of scanning for a channel by a second electronic device according to an embodiment of the disclosure.

As illustrated in FIG. 5, in operation 510, the second electronic device 202 may establish a connection with the first electronic device 201. More specifically, the second electronic device 202 may establish a connection with the first electronic device 201 searching for a surrounding electronic device.

According to an embodiment, the second electronic device 202 may receive a second message including information related to a channel scan request from the first electronic device 201. The second electronic device 202 may receive a second message including information related to a channel scan request through a BLE advertising packet or the second electronic device 202 may indirectly receive the second message from the first electronic device 201 through a server. For example, the first electronic device 201 and the second electronic device 202 may be connected through the server or connected through BLE communication.

The second message may include information relating to whether a scan operation of the second electronic device 202 is to be made. The second message may include information relating to whether the second electronic device 202 is to negotiate with the first electronic device 201 when scanning for a channel. The second message may include at least one of information on a Wi-Fi class utilized for channel scanning or information relating to whether there is a negotiation between the first electronic device 201 and the second electronic device 202 at the time of channel scanning. Specific information included in the second message will be described later.

According to an embodiment, the second electronic device 202 may establish a wireless connection with the first electronic device 201 based on a BLE advertising packet. More specifically, the second electronic device 202 may establish a BLE connection with the first electronic device 201 based on a BLE advertising packet. However, the wireless connection between the second electronic device 202 and the first electronic device 201 is not limited to a BLE communication method, and the wireless connection may be established through a WLAN or the server.

According to an embodiment, the second electronic device 202 may transmit, to the first electronic device 201, a third message including information relating to whether the second electronic device 202 is able to perform channel scanning. For example, the second electronic device 202 may transmit a third message to the first electronic device 201 as a response to the second message received from the first electronic device 201. The third message may include at least one of information on a Wi-Fi class supported by the second electronic device 202 or information relating to whether the second electronic device 202 can perform channel scanning. For example, the third message may include information indicating that the second electronic device 202 is able to perform channel scanning. The third message may include information indicating that the second electronic device 202 is unable to perform channel scanning. Specific information included in the third message will be described later.

In operation 520, the second electronic device 202 may negotiate a channel scan condition with the first electronic device 201.

According to an embodiment, the second electronic device 202 may receive a fourth message including a condition of channel scanning from the first electronic device 201. The fourth message may include information relating to a channel preferred by the first electronic device 201. The fourth message may include at least one of information on a channel or information on a band preferred by the first electronic device 201. The fourth message may include weight information utilized for channel score calculation or information relating to whether there is a negotiation between the first electronic device 201 and the second electronic device 202 at the time of channel scanning.

According to an embodiment, in response to the fourth message including information on a condition of channel scanning, the second electronic device 202 may transmit, to the first electronic device 201, a fifth message including information relating to whether the second electronic device 202 is to accept the condition of channel scanning. The fifth message may include at least one of information on a band supported by the second electronic device 202, information on a channel supported by the second electronic device 202, or information indicating whether the second electronic device 202 is to perform channel scanning. For example, the second electronic device 202 may transmit, to the first electronic device 201, a fifth message including information indicating that the condition of channel scanning is accepted. For example, the second electronic device 202 may transmit, to the first electronic device 201, a fifth message including information indicating that the condition of channel scanning is rejected.

According to an embodiment, when the second electronic device 202 transmits, to the first electronic device 201, a fifth message indicating that a condition of channel scanning is not accepted, the second electronic device 202 may receive a fourth message including the condition of channel scanning from the first electronic device 201 again. The first electronic device 201 and the second electronic device 202 may negotiate a condition of channel scanning to be performed by the second electronic device 202 while transmitting and receiving a fourth message including information on the condition of channel scanning and a fifth message including information relating to whether to accept the condition of channel scanning.

In operation 530, the second electronic device 202 may perform channel scanning.

According to an embodiment, the second electronic device 202 may perform channel scanning based on information included in the fourth message from the first electronic device 201. For example, the second electronic device 202 may perform channel scanning based on information on a band preferred by the first electronic device 201 included in the fourth message. For example, the second electronic device 202 may perform channel scanning based on information on a channel preferred by the first electronic device 201 included in the fourth message.

According to an embodiment, the second electronic device 202 may scan for a channel relating to Wi-Fi communication. For example, the second electronic device 202 may scan for a channel through a MAC sublayer management entity (MLME) measure. The second electronic device 202 may measure channel utilization, signal quality, a beacon report, a frame statistics, noise, etc.

According to an embodiment, the second electronic device 202 may scan for a channel in a manner of transmitting and receiving a signal to and from an access point (AP). For example, the second electronic device 202 may receive a beacon signal from the AP. The second electronic device 202 may transmit a probe request signal to the AP and receive a probe response signal from the AP as a response therefor. For example, the second electronic device 202 may obtain BSS load information from a received probe response. For example, the second electronic device 202 may measure a response time indicating a time interval between a probe request signal and a probe response signal that are repeated for a predetermined time, or a response rate of a probe response to a repeatedly transmitted probe request signal. In an embodiment, the second electronic device 202 may perform a radio measurement to obtain radio measurement result information and scan for an empty channel, based on the radio measurement result information. When there is no empty channel, the second electronic device 202 may scan for a channel.

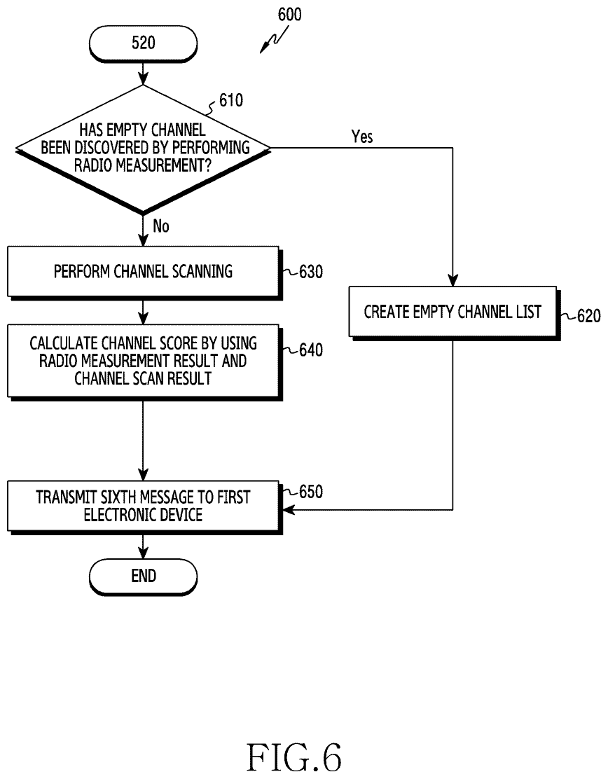

However, channel scan methods and types are not limited to the above examples, and a detailed operation of scanning for a channel by the second electronic device 202 will be described with reference to FIG. 6 later.

In operation 540, the second electronic device 202 may calculate a channel score based on a scan result.

According to an embodiment, the second electronic device 202 may calculate a channel score based on information obtained as a result of channel scanning. For example, the second electronic device 202 may calculate a channel score by using BSS load information obtained as a result of channel scanning. The BSS load information may include at least one of channel utilization information indicating a congestion level of a channel, station count information indicating the number of clients connected to a channel, or available admission capacity information indicating an admissible capacity of a channel. For example, the second electronic device 202 may calculate a channel score by using estimation information obtained as a result of channel scanning. The estimation information may include at least one of response time information and response rate information.

According to an embodiment, the second electronic device 202 may calculate a channel score by using weight information with respect to information obtained as a result of channel scanning. For example, the weight information may include a BSS load weight and an estimation weight. The BSS load weight may be a weight to be applied to the BSS load information. The estimation weight may be a weight to be applied to the weight information. A detailed description of a channel score and a weight will be given with reference to FIG. 6 later.

In operation 550, the second electronic device 202 may transmit the channel score to the first electronic device 201.

In an embodiment, the second electronic device 202 may transmit a sixth message including a channel score to the first electronic device 201. The second electronic device 202 may calculate a channel score based on a channel scan result, and transmit a sixth message including the channel score to the first electronic device 201. For example, the channel score may include a channel-specific score obtained by calculating the channel score of each channel obtained through scanning by the second electronic device 202.

In an embodiment, the sixth message may include feature information of the second electronic device 202. The feature information of the second electronic device 202 may include the Wi-Fi version of the second electronic device 202 or the number of antennas of the second electronic device 202. For example, the first electronic device 201 may use the feature information of the second electronic device 202 received from the second electronic device 202, to select an optimal channel.

FIG. 6 illustrates a flowchart 600 of a method of performing channel scanning by a second electronic device 202 according to an embodiment of the disclosure.

As illustrated in FIG. 6, the second electronic device 202 may negotiate a channel scan condition with the first electronic device 201. The second electronic device 202 may perform an operation corresponding to the operation 520 in FIG. 5.

According to an embodiment, the second electronic device 202 may accept a channel scan condition with the first electronic device 201 and transmit a fifth message to the first electronic device 201. Thereafter, the second electronic device 202 may perform channel scanning.

In operation 610, the second electronic device 202 may perform a radio measurement to determine whether there is an empty channel.

According to an embodiment, the second electronic device 202 may perform a radio measurement. The second electronic device 202 may perform a radio measurement by using a physical layer parameter. The second electronic device 202 may perform a radio measurement on a physical (PHY) layer to explore whether a particular channel is in use. More specifically, the second electronic device 202 may perform a radio measurement to find an empty channel. The second electronic device 202 may determine whether there is an empty channel in a method of performing a radio measurement to detect an energy level of a particular channel. For example, the second electronic device 202 may perform a radio measurement to obtain a signal strength, a signal noise ratio (SNR), inter-cell interference, transmission delay, data speed, etc., and determine whether there is an empty channel through radio measurement result information.

According to an embodiment, the second electronic device 202 may perform a radio measurement to determine whether other devices are using channels. Specifically, the second electronic device 202 may receive, from the first electronic device 201, a message that requests to perform a radio measurement, and measure whether other electronic devices are using channels accordingly. For example, a fourth message, requesting channel scanning, received by the second electronic device 202 from the first electronic device 201 may include information indicating that the first electronic device 201 has requested the second electronic device 202 to perform a radio measurement. The second electronic device 202 may, in response to the message that requests to perform a radio measurement, transmit an acknowledgement (ACK) message indicating that the second electronic device 202 will perform the radio measurement, to the first electronic device 201. A fifth message may include acknowledgement (ACK) information indicating that the second electronic device will perform the radio measurement. Accordingly, the second electronic device 202 may perform the radio measurement to determine whether there are other electronic devices connected to the AP.

According to an embodiment, when an empty channel is discovered during a radio measurement, the second electronic device 202 may perform operation 620. According to an embodiment, when an empty channel is not discovered during the radio measurement, the second electronic device 202 may perform operation 630.

In operation 620, the second electronic device 202 may create an empty channel list.

According to an embodiment, when an empty channel is discovered, the second electronic device 202 may create a channel list including the empty channel. The empty channel may indicate a channel that no one is using. For example, since an empty channel is a channel that no one is using, when there is an empty channel, the second electronic device 202 may create a channel list including the empty channel and transmit the list to the first electronic device 201.

In operation 630, the second electronic device 202 may perform channel scanning.

In an embodiment, the operation 630 in FIG. 6 may correspond to the operation 530 in FIG. 5.

According to an embodiment, when there is no empty channel, the second electronic device 202 may perform channel scanning by using a media access control (MAC) layer parameter. When the second electronic device 202 has failed to discover an empty channel according to performing a radio measurement, the second electronic device 202 may perform channel scanning by using a MAC layer parameter. For example, the radio measurement may be performed in a manner of measuring a signal strength by using a PHY layer parameter. Note that when channel scanning is performed using a MAC layer parameter, more time and power are consumed as compared to using a PHY layer parameter. Therefore, the second electronic device 202 may perform a radio measurement and then when there is no empty channel, may perform channel scanning by using a MAC layer parameter.

According to an embodiment, the second electronic device 202 may perform channel scanning by using a MAC layer parameter. Specifically, the second electronic device 202 may analyze a beacon frame or probe frame to perform channel scanning. According to an embodiment, the second electronic device 202 may obtain BSS load information included in a beacon frame or probe frame through channel scanning. The BSS load information may include at least one of channel utilization information indicating a congestion level of a channel, station count information indicating the number of clients connected to a channel, or available admission capacity information indicating an admissible capacity of a channel. According to an embodiment, the second electronic device 202 may analyze a beacon frame or probe frame to obtain estimation information. The estimation information may include at least one of response time information indicating a time interval between a probe request message repeatedly transmitted by the second electronic device 202 to the AP for a predetermined time and a probe response message repeatedly transmitted by the AP to the second electronic device 202 for a predetermined time in response to the probe request message, or information on a response rate of the probe response message of the AP to a probe request message repeatedly transmitted by the second electronic device 202 to the AP for a predetermined time.

However, channel scanning using a PHY layer parameter or channel scanning using a MAC layer described above may be performed sequentially or in parallel. In addition, any one of scan operations may be omitted during execution. In addition, a channel scan method of the second electronic device 202 is not limited to performing a radio measurement and channel scanning using a MAC layer parameter.

In operation 640, the second electronic device 202 may calculate a channel score by using a radio measurement result and a channel scan result.

In an embodiment, operation 640 in FIG. 6 may be an operation corresponding to operation 540 in FIG. 5.

$${S}_{Ch} = {W}_{Load} * {S}_{load} + {W}_{Est} * ( \frac{{\sum }_{i}^{n} {S}_{i}}{n} ) \qquad [ Equation l ]$$

$$\{ i = Probe Req \& Res Delay , Retry Rate , CCA , RPI , Channel Load , … \}$$

According to an embodiment, referring to Equation 1 above, a channel score (Sch) may be calculated by applying a BSS load weight (w_{Load}) to a BSS load score (S_{load}) based on the BSS load information, and applying an estimation weight (w_{Est}) to each of scores (Sᵢ) of pieces of estimation information, based on the estimation information. Specifically, the first electronic device 201 may configure the sum of a BSS load weight and an estimation weight to be 100%, and transmit the weight information including the BSS load weight and the estimation weight to the second electronic device 202. The second electronic device 202 may calculate a channel score by using the weight information received from the first electronic device 201. In Equation 1 above, i may indicate pieces of the estimation information. Referring to Equation 1, the estimation information may include a delay time between a probe request and a probe response (an average time after probe request transmission until probe response reception), a response rate to a probe request, clear channel assessment (CCA) that determines whether a wireless channel is in use or empty, a received power indicator (RPI) indicating a power level of a signal received in a wireless channel, or channel load information indicating a load state of a channel. However, Equation 1 above shows an example of calculating a channel score, and a method of calculating a channel score is not limited to only the Equation 1 above.

Referring to Equation 1 above, if a BSS load weight is large, a channel having a good channel state according to the BSS load information may be measured to have a high channel score. On the other hand, if the estimation weight is large, a channel determined to be smooth according to pieces of the estimation information, rather than the BSS load information, may be measured to have a high channel score. The first electronic device 201 may configure different weight information to be utilized in determining which information is more reliable among information acquirable through the BSS load information and the estimation information acquirable by estimating pieces of information obtained in a process of scanning for a channel.

In an embodiment, the second electronic device 202 may receive BSS load information from a beacon frame or a probe response message. The BSS load information may include at least one of channel utilization information indicating a congestion level of a channel, station count information indicating the number of clients connected to a channel, or available admission capacity information indicating an admissible capacity of a channel. However, the BSS load information is not limited to the above example, and may include other pieces of information acquirable from a beacon frame or a probe response message.

In an embodiment, the second electronic device 202 may obtain estimation information in a channel scan process. In an embodiment, the second electronic device 202 may, in a channel scan process, obtain response time information indicating a time interval between a probe request message transmitted by the second electronic device 202 to the AP and a probe response message transmitted by the AP to the second electronic device 202 in response to the probe request message. In an embodiment, the second electronic device 202 may obtain information on a response rate of a probe response to a probe request signal repeatedly transmitted for a predetermined time. The second electronic device 202 may obtain radio measurement result information through a radio measurement. However, the estimation information obtained by the second electronic device 202 is not limited to the above example, and may include other information related to a channel state acquirable in a channel scan process.

In operation 650, the second electronic device 202 may transmit, to the first electronic device 201, a sixth message including information on a result of scanning for a channel by the second electronic device 202. The sixth message may include a channel score obtained based on a channel scan result by the second electronic device 202. The sixth message may include feature information of the second electronic device 202. A detailed configuration of the sixth message will be described later.

In an embodiment, the operation 650 in FIG. 6 may correspond to the operation 550 in FIG. 5.

FIG. 7 illustrates a flowchart 700 depicting messages transmitted and received between a first electronic device and a second electronic device according to an embodiment of the disclosure.

In an embodiment, operation 320, operation 330, operation 340, and operation 350 in FIG. 7 may correspond to the operation 320, operation 330, operation 340, and operation 350 in FIG. 3.

In an embodiment, operation 510, operation 520, operation 530, operation 540, and operation 550 of FIG. 7 may correspond to the operation 510, operation 520, operation 530, operation 540, and operation 550 in FIG. 5.

According to an embodiment, the first electronic device 201 may transmit a second message 702 to the second electronic device 202. For example, the first electronic device 201 may broadcast the second message 702 to the second electronic device 202 through a BLE advertising packet. The first electronic device 201 may transmit the second message 702 to the second electronic device 202 through a server.

According to an embodiment, the second message 702 may be a message including information related to a channel scan request. For example, the second message 702 may include information relating to whether a scan operation of the second electronic device 202 is to be made. The second message 702 may include information relating to whether a negotiation with the first electronic device 201 is to be made in a scan operation of the second electronic device 202. The second message 702 may include information on a minimum Wi-Fi class utilized when the second electronic device 202 performs scanning. The second message 702 may include an ID of a transmission device and an ID of a reception device.

According to an embodiment, the second electronic device 202 may transmit a third message 703 to the first electronic device 201. For example, the second electronic device 202 having directly established a wireless communication connection with the first electronic device 201 may transmit the third message 703 to the first electronic device 201. For example, the second electronic device 202 having indirectly established a wireless communication connection with the first electronic device 201 through a server may transmit the third message to the first electronic device 201.

According to an embodiment, the third message 703 may be a message including information relating to whether to be able to perform channel scanning. For example, the third message 703 may include information relating to whether the second electronic device 202 is to participate in a channel scan operation. The third message 703 may include information relating to whether the second electronic device 202 is to perform channel scanning. The third message 703 may include information relating to whether the second electronic device 202 is able to support a channel scan operation. The third message 703 may include information on a Wi-Fi class supported when the second electronic device 202 performs scanning. The third message 703 may include an ID of a transmission device and an ID of a reception device.

According to an embodiment, the first electronic device 201 may transmit a fourth message 704 to the second electronic device 202.

According to an embodiment, the fourth message 704 may include information relating to a condition requested by the first electronic device 201 when the second electronic device 202 scans for a channel. For example, the fourth message 704 may include information on a channel preferred by the first electronic device 201. The fourth message 704 may include information on a band preferred by the first electronic device 201. The fourth message 704 may include weight information utilized for channel score calculation. The fourth message 704 may include information on a method of transmitting the fourth message 704. The fourth message 704 may include information relating to whether there is a negotiation between the first electronic device 201 and the second electronic device 202 at the time of channel scanning.

According to an embodiment, the second electronic device 202 may transmit a fifth message 705 to the first electronic device 201.

According to an embodiment, the fifth message 705 may include information relating to whether the second electronic device 202 is to accept a condition requested by the first electronic device 201 at the time of channel scanning. For example, the fifth message 705 may include information relating to whether to accept the condition included in the fourth message 704. For example, the fifth message 705 may include information on a channel supported by the second electronic device 202. The fifth message 705 may include information on a band supported by the second electronic device 202. The fifth message 705 may include weight information utilized for channel score calculation. The fifth message 705 may include information on a method of transmitting the fifth message 705.

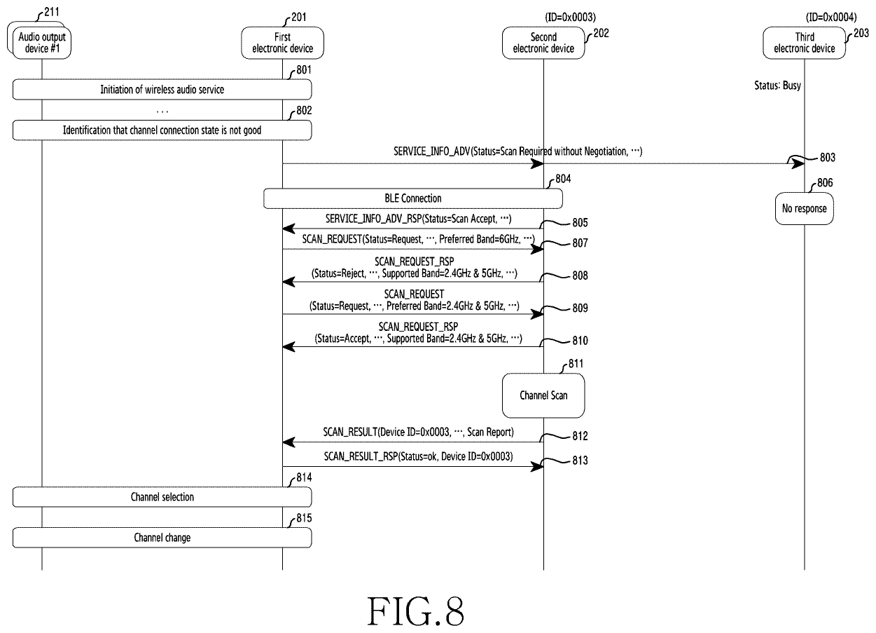

According to an embodiment, when the fifth message 705 includes information indicating that the second electronic device 202 has rejected a condition requested by the first electronic device 201, the first electronic device 201 may transmit the fourth message 704 to the second electronic device 202 again. Such a signal for negotiating a channel scan condition will be described with reference to FIG. 8 later.

According to an embodiment, the second electronic device 202 may transmit a sixth message 706 to the first electronic device 201.

According to an embodiment, the sixth message 706 may include information on a result of scanning for a channel by the second electronic device 202. For example, the sixth message 706 may include a channel score obtained based on a channel scan result by the second electronic device 202. The sixth message 706 may include feature information including a Wi-Fi version or the number of antennas of the second electronic device 202. The sixth message 706 may include an ID of the second electronic device 202. The sixth message 706 may include weight information utilized for channel score calculation. The sixth message 706 may include information on a channel preferred by the first electronic device 201. The sixth message 706 may include information on a band preferred by the first electronic device 201.

According to an embodiment, the first electronic device 201 may transmit a message 707 responding to the sixth message 706 to the second electronic device 202.

According to an embodiment, the message 707 responding to the sixth message 706 may include information relating to whether the sixth message 706 has been received. The message 707 responding to the sixth message 706 may include an ID of the second electronic device 202.

FIG. 8 illustrates a diagram depicting signals exchanged between an audio output device, a first electronic device, a second electronic device, and a third electronic device in a process of selecting a channel by the first electronic device according to an embodiment of the disclosure.

As illustrated in FIG. 8, in operation 801, the first electronic device 201 and audio output device #1 211 may provide a wireless audio service.

In operation 802, it may be identified that a channel connection state between the first electronic device 201 and audio output device #1 211 is not good. For example, the first electronic device 201 may receive, from the audio output device, a first message including information on a connection state of a channel between the first electronic device 201 and audio output device #1 211, and identify that the channel connection state is not good. For example, the first electronic device 201 may identify that the channel connection state is not good, through pieces of information included in the first message, and when the channel connection state is not good, the first electronic device 201 may indicate that a low quality service has occurred.

In operation 803, the first electronic device 201 may broadcast a second message including information related to a channel scan request through a BLE advertising packet. Referring to FIG. 8, the second electronic device 202 may receive the BLE advertising packet. The third electronic device 203 may receive the BLE advertising packet. As illustrated in FIG. 8, the second message may be a SERVICE_INFO_ADV message. The second message may include state information. For example, when the state information included in the second message indicates ‘Scan Required without Negotiation,’ this may imply that when a channel scan condition provided by the second electronic device 202 does not meet a condition requested by the first electronic device 201, a response is not to be made.

In operation 804, the second electronic device 202 and the first electronic device 201 may establish a connection through BLE communication. For example, referring to FIG. 8, the second electronic device 202 may establish a BLE connection with the first electronic device 201 based on information included in the SERVICE_INFO_ADV message of the first electronic device 201.

In operation 805, the second electronic device 202 may transmit a third message to the first electronic device 201. The third message may include information indicating that the second electronic device 202 is able to support a channel scan operation. As illustrated in FIG. 8, the third message may be a SERVICE_INFO_ADV_RSP message. The third message may include state information, and when the state information included in the third message indicates ‘Scan Accept,’ this may imply that the second electronic device 202 is able to support a channel scan operation.

In operation 806, the third electronic device 203 may not respond to the second message of the first electronic device 201. For example, the third electronic device 203 may not be able to perform channel scanning because the third electronic device 203 is performing another service. In this case, according to ‘Scan Required without Negotiation’ being indicated by the state information included in the second message, when a channel scan condition provided by the third electronic device 203 does not meet a condition requested by the first electronic device 201, the third electronic device 203 may not respond. Therefore, referring to FIG. 8, the third electronic device 203 may not respond to the first electronic device 201.

In operation 807, the first electronic device 201 may transmit a fourth message to the second electronic device 202. As illustrated in FIG. 8, the fourth message may be a SCAN_REQUEST message. The fourth message may include information that requests the second electronic device 202 to perform scanning and information on a preferred band of the first electronic device 201. For example, when the preferred band information included in the fourth message indicates 6 GHz, this may imply that the first electronic device 201 prefers a band of 6 GHz. For example, when state information of the fourth message indicates ‘Request,’ this may indicate requesting of the second electronic device 202 to perform scanning.

In operation 808, the second electronic device 202 may transmit a fifth message to the first electronic device 201. As illustrated in FIG. 8, the fifth message may be a SCAN_REQUEST_RSP message. The fifth message according to operation 808 may include information indicating that the second electronic device 202 has rejected a channel scan request, and information on a band supported by the second electronic device 202. For example, when the supported band information included in the fifth message indicates ‘2.4 GHz & 5 GHz,’ this may imply that the second electronic device 202 is able to support channel scanning in channel bands of 2.4 GHz and 5 GHz. For example, when state information of the fifth message indicates ‘Reject,’ this may indicate that the supported band of the second electronic device 202 and the preferred band of the first electronic device 201 are different and thus the second electronic device 202 is not able to perform channel scanning. For example, according to operation 808, a negotiation of a channel scan condition between the first electronic device 201 and the second electronic device 202 may not have been accepted.

In operation 809, the first electronic device 201 may transmit a fourth message to the second electronic device 202. As illustrated in FIG. 8, the fourth message may be a SCAN_REQUEST message. The fourth message according to operation 809 may include information reflecting a band providable by the second electronic device 202. The fourth message may include information that requests the second electronic device 202 to perform scanning and information on a preferred band of the first electronic device 201. For example, when the preferred band information included in the fourth message indicates ‘2.4 GHz & 5 GHz,’ this may imply that the first electronic device 201 prefers bands of 2.4 GHz and 5 GHz. For example, when state information of the fourth message indicates ‘Request,’ this may indicate requesting of the second electronic device 202 to perform scanning.

In operation 810, the second electronic device 202 may transmit a fifth message to the first electronic device 201. As illustrated in FIG. 8, the fifth message may be a SCAN_REQUEST_RSP message. The fifth message according to operation 810 may include information indicating that the second electronic device 202 has accepted a channel scan request, and information on a band providable by the second electronic device 202. For example, when the supported band information included in the fifth message indicates ‘2.4 GHz & 5 GHz,’ this may imply that the second electronic device 202 is able to support channel scanning in channel bands of 2.4 GHz and 5 GHz. For example, when state information of the fifth message indicates ‘accept,’ this may indicate that the supported band of the second electronic device 202 and the preferred band of the first electronic device 201 match and thus the second electronic device 202 is able to perform channel scanning. For example, according to operation 810, a negotiation of a channel scan condition between the first electronic device 201 and the second electronic device 202 may have been accepted.

In operation 811, the second electronic device 202 may perform channel scanning. The second electronic device 202 may perform channel scanning in channel bands of 2.4 GHz and 5 GHz. In an embodiment, based on the acceptance of a negotiation of a channel scan condition between the first electronic device 201 and the second electronic device 202, the second electronic device 202 may perform channel scanning according to the accepted channel scan condition.

In an embodiment, the second electronic device 202 may perform channel scanning according to the accepted channel scan condition and calculate a channel score.

In operation 812, the second electronic device 202 may transmit a sixth message to the first electronic device 201. As shown in FIG. 8, the sixth message may be a SCAN_RESULT message. Referring to FIG. 8, the sixth message according to operation 812 may include device ID information and a scan report. For example, the device ID information may indicate ‘0x0003,’ a value corresponding to the second electronic device 202. The sixth message may include a scan report that is a channel estimation result based on a result of scanning for a channel by the second electronic device 202. For example, the scan report may include a channel score calculated by the second electronic device 202. The scan report may include a channel list including an empty channel if the empty channel exists.

In operation 813, the first electronic device 201 may transmit a message responding to a scan estimation result to the second electronic device 202. As shown in FIG. 8, the message responding to the scan estimation result may be a SCAN_RESULT_RSP message. The message according to operation 813 may include a device ID information and state information indicating that the first electronic device 201 has received the sixth message. The device ID information indicates ‘0x0003’ that is a value corresponding to the second electronic device 202. For example, when the state information of the SCAN_RESULT_RSP message indicates ‘ok’, this may indicate that the first electronic device 201 has received a channel scan result of the second electronic device 202.

In operation 814, the first electronic device 201 may select an optimal channel, based on a channel estimation result based on a result of scanning for a channel by the second electronic device 202. In an embodiment, operation 814 may be a partial operation of operation 350 in FIG. 3.

In operation 815, the first electronic device 201 may change the channel between the first electronic device 201 and audio output device #1 211 to the selected optimal channel. In an embodiment, operation 815 may be a partial operation of the operation 350 in FIG. 3.

While respective signals or messages are illustrated as being sequentially transmitted and received in FIG. 8, the disclosure is not limited thereto, and respective signals or messages illustrated in FIG. 8 may be transmitted and received simultaneously or in parallel, and the sequence thereof may be changed.

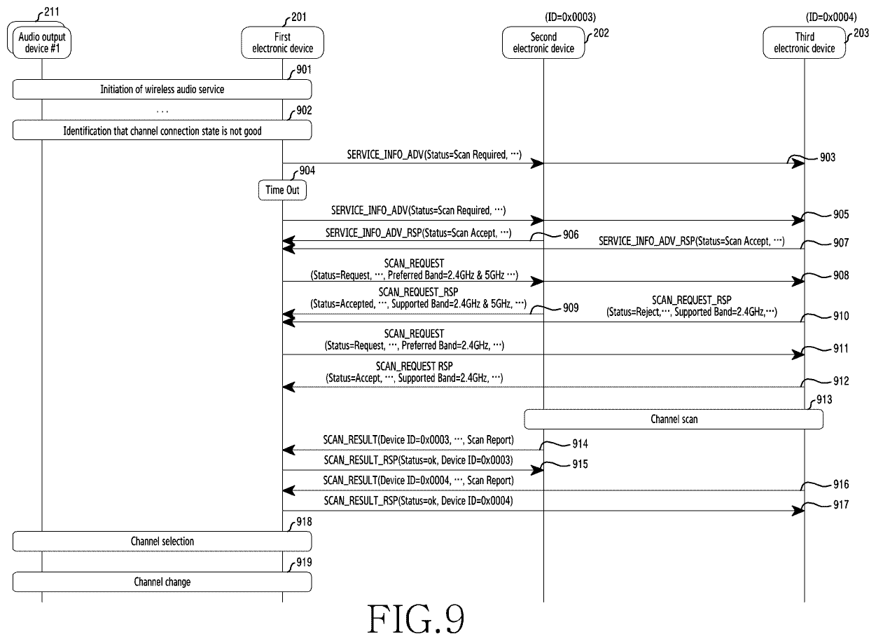

FIG. 9 illustrates a diagram depicting signals exchanged between an audio output device, a first electronic device, a second electronic device, and a third electronic device in a process of selecting a channel by the first electronic device according to an embodiment of the disclosure.

In an embodiment, operation 901 in FIG. 9 may correspond to the operation 801 in FIG. 8. In an embodiment, operation 902 in FIG. 9 may correspond to the operation 802 in FIG. 8.

In operation 903, the first electronic device 201 may broadcast a second message including information related to a channel scan request through a BLE advertising packet. As shown in FIG. 9, the second message may be a SERVICE_INFO_ADV message. The second message according to operation 903 may include state information. For example, when the state information included in the second message indicates ‘Scan Required,’ this may imply that, when a channel scan condition provided by the second electronic device 202 does not meet a condition requested by the first electronic device 201, the first electronic device 201 will perform a negotiation process after receiving a response from a surrounding electronic device.

In operation 904, the first electronic device 201 may fail to discover a surrounding electronic device for a threshold time. In an embodiment, when a wireless connection with the second electronic device 202 and the third electronic device 203 is not established for the threshold time in response to the BLE advertising packet of the first electronic device 201, the first electronic device 201 may determine that there is no surrounding electronic device. For example, there has been no response for the second message of the first electronic device 201 from the second electronic device 202 and the third electronic device 203 for a predetermined time, and thus the first electronic device 201 may have failed to discover a surrounding electronic device. In this case, the first electronic device 201 may discover a surrounding electronic device through a server.

In operation 905, the first electronic device 201 may transmit a second message to the second electronic device 202 and the third electronic device 203 through the server. As illustrated in FIG. 9, the second message may be a SERVICE_INFO_ADV message. The second message according to the operation 905 may include state information. For example, when the state information included in the second message indicates ‘Scan Required,’ this may imply that, when a channel scan condition provided by the second electronic device 202 does not meet a condition requested by the first electronic device 201, the first electronic device 201 will perform a negotiation process after receiving a response from a surrounding electronic device. For example, in the operation 905, the second message may be transmitted to a surrounding electronic device through the server unlike the operation 903.

In operation 906, the second electronic device 202 may transmit a third message to the first electronic device 201. For example, the third message may include information indicating that the second electronic device 202 is able to support a channel scan operation. The third message in the operation 906 may be a SERVICE_INFO_ADV_RSP message. The third message may include state information, and when the state information included in the third message in the operation 906 indicates ‘Scan Accept,’ this may indicate that the second electronic device 202 is able to support a channel scan operation.

In operation 907, the third electronic device 203 may transmit a third message to the first electronic device 201. For example, the third message may include information indicating that the third electronic device 203 is able to support a channel scan operation. In the operation 907 of FIG. 9, the third message may be a SERVICE_INFO_ADV_RSP message. The third message may include state information, and when the state information included in the third message in the operation 907 indicates ‘Scan Accept,’ this may indicate that the third electronic device 203 is able to support a channel scan operation.

In operation 908, the first electronic device 201 may transmit a fourth message to the second electronic device 202 and the third electronic device 203. In the operation 908 of FIG. 9, the fourth message may be a SCAN_REQUEST message. The fourth message may include information that requests the second electronic device 202 and the third electronic device 203 to perform scanning and information on a preferred band of the first electronic device 201. For example, when the preferred band information included in the fourth message indicates ‘2.4 GHz & 5 GHz,’ this may imply that the first electronic device 201 prefers bands of 2.4 GHz and 5 GHz. For example, when state information of the fourth message indicates ‘Request,’ this may indicate requesting of the second electronic device 202 and the third electronic device 203 to perform scanning.

In operation 909, the second electronic device 202 may transmit a fifth message to the first electronic device 201. Referring to FIG. 9, the fifth message according to the operation 909 may be a SCAN_REQUEST_RSP message. The fifth message according to the operation 909 may include information indicating that the second electronic device 202 has accepted a channel scan request, and information on a band providable by the second electronic device 202. For example, when the supported band information included in the fifth message indicates ‘2.4 GHz & 5 GHz,’ this may imply that the second electronic device 202 is able to support channel scanning in channel bands of 2.4 GHz and 5 GHz. For example, when state information of the fifth message indicates ‘accept,’ this may indicate that the supported band of the second electronic device 202 and the preferred band of the first electronic device 201 match and thus the second electronic device 202 is able to perform channel scanning. For example, according to the operation 909, a negotiation of a channel scan condition between the first electronic device 201 and the second electronic device 202 may have been accepted.

In operation 910, the third electronic device 203 may transmit a fifth message to the first electronic device 201. For example, referring to FIG. 9, the fifth message according to the operation 910 may be a SCAN_REQUEST_RSP message. The fifth message according to the operation 910 may include information indicating that the third electronic device 203 has rejected a channel scan request, and information on a band supported by the third electronic device 203. For example, when the supported band information included in the fifth message indicates ‘2.4 GHz,’ this may imply that the third electronic device 203 is able to support channel scanning in a channel band of 2.4 GHz. For example, when state information of the fifth message indicates ‘Reject,’ this may indicate that the supported band of the third electronic device 203 and the preferred band of the first electronic device 201 are different and thus the third electronic device 203 is not able to perform channel scanning. For example, according to operation 910, a negotiation of a channel scan condition between the first electronic device 201 and the third electronic device 203 may not have been accepted.

In operation 911, the first electronic device 201 may transmit a fourth message to the third electronic device 203. For example, referring to FIG. 9, the fourth message according to the operation 911 may be a SCAN_REQUEST message. The fourth message according to operation 911 may include information reflecting a band providable by the third electronic device 203. The fourth message may include information that requests the third electronic device 203 to perform scanning and information on a preferred band of the first electronic device 201. For example, when the preferred band information included in the fourth message indicates ‘2.4 GHz,’ this may imply that the first electronic device 201 prefers a band of 2.4 GHz. For example, when state information of the fourth message indicates Request, this may indicate requesting of the third electronic device 203 to perform scanning.

In operation 912, the third electronic device 203 may transmit a fifth message to the first electronic device 201. For example, the fifth message according to the operation 912 may be a SCAN_REQUEST_RSP message. The fifth message according to the operation 912 may include information indicating that the third electronic device 203 has accepted a channel scan request, and information on a band providable by the third electronic device 203. For example, when the supported band information included in the fifth message indicates ‘2.4 GHz,’ this may imply that the third electronic device 203 is able to support channel scanning in a channel band of 2.4 GHz. For example, when state information of the fifth message indicates accept, this may indicate that the supported band of the third electronic device 203 and the preferred band of the first electronic device 201 match and thus the third electronic device 203 is able to perform channel scanning. For example, according to the operation 912, a negotiation of a channel scan condition between the first electronic device 201 and the third electronic device 203 may have been accepted.

In operation 913, the second electronic device 202 and the third electronic device 203 may perform channel scanning. The second electronic device 202 in the operation 913 may perform channel scanning in channel bands of 2.4 GHz and 5 GHz. The third electronic device 203 may perform channel scanning in a channel band of 2.4 GHz.

In operation 914, the second electronic device 202 may transmit a sixth message to the first electronic device 201. For example, referring to FIG. 9, the sixth message according to the operation 914 may include device ID information and a scan report. The device ID information indicates ‘0x0003’ that is a value corresponding to the second electronic device 202. The sixth message may include a scan report that is a channel estimation result based on a result of scanning for a channel by the second electronic device 202. For example, the scan report may include a channel score calculated by the second electronic device 202 after performing channel scanning in channel bands of 2.4 GHz and 5 GHz.

In operation 915, the first electronic device 201 may transmit a message responding to a scan estimation result to the second electronic device 202. For example, the message according to the operation 915 may include ‘0x0003’ that is ID information of the second electronic device 202 and state information indicating that the first electronic device 201 has received the sixth message.

In operation 916, the third electronic device 203 may transmit a sixth message to the first electronic device 201. For example, referring to FIG. 9, the sixth message according to the operation 916 may include device ID information and a scan report. The device ID information may indicate ‘0x0004’ that is a value corresponding to the third electronic device 203. The sixth message may include a scan report that is a channel estimation result based on a result of scanning for a channel by the third electronic device 203. For example, the scan report may include a channel score calculated by the third electronic device 203 after performing channel scanning in a channel band of 2.4 GHz.

In operation 917, the first electronic device 201 may transmit a SCAN_RESULT_RSP message responding to the second electronic device 202 that a scan estimation result has been received. For example, the SCAN_RESULT_RSP message according to the operation 915 may include ‘0x0003’ indicating a value corresponding to the second electronic device 202 and state information indicating that the first electronic device 201 has received the sixth message.

In operation 918, the first electronic device 201 may select an optimal channel, based on channel estimation results based on results of scanning for a channel by the second electronic device 202 and the third electronic device 203. For example, the first electronic device 201 may select an optimal channel, based on results of scanning for a channel by multiple external electronic devices.

In operation 919, the first electronic device 201 may change the channel between the first electronic device 201 and audio output device #1 211 to the selected optimal channel.

In FIG. 9, respective signals or messages are illustrated as being sequentially transmitted and received, but the disclosure is not limited thereto, and respective signals or messages illustrated in FIG. 9 may be transmitted and received simultaneously or in parallel, and the sequence thereof may be changed.

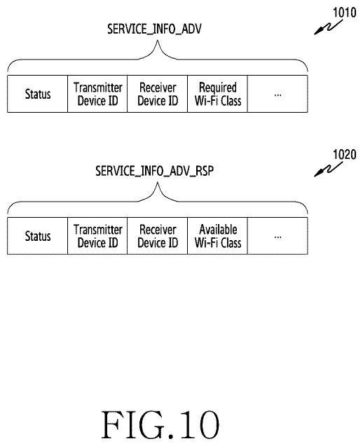

FIG. 10 illustrates example formats of second and third messages 1010 and 1020 according to an embodiment of the disclosure.

According to an embodiment, the second message 1010 may be a message transmitted by the first electronic device 201 to the second electronic device 202. The second message 1010 may include information relating to whether a scan operation of the second electronic device 202 is to be performed. As illustrated in FIG. 10, the second message 1010 may be a SERVICE_INFO_ADV message. The second message 1010 may include, for example, a status field, a transmitter device ID field, a receiver device ID field, and a required Wi-Fi class field. The status field may include information relating to whether a negotiation with the first electronic device 201 is to be made in a scan operation of the second electronic device 202, the transmitter device ID field may include ID information of a transmission device, the receiver device ID field may include ID information of a reception device, and the required Wi-Fi class field may include information on a minimum Wi-Fi class required when the second electronic device 202 performs scanning.

According to an embodiment, the second message may include information relating to whether a negotiation with the first electronic device 201 is to be performed in a scan operation of the second electronic device 202. For example, if a status value is 0, this may indicate state information indicating a suggestion to respond to and then negotiate with the first electronic device 201 when a scan execution condition requested by the first electronic device 201 does not meet a scan execution condition of the second electronic device 202. If the status value is 0, this may indicate ‘Scan required’. For example, if the status value is 1, this may indicate state information indicating that it may not respond to the first electronic device 201 when a scan execution condition requested by the first electronic device 201 does not meet a scan execution condition of the second electronic device 202. If the status value is 1, this may indicate ‘Scan required without negotiation’.

According to an embodiment, the second message 1010 may include ID information of a transmission device. For example, a transmitter device ID value may indicate a value corresponding to the first electronic device 201.

According to an embodiment, the second message 1010 may include ID information of a reception device. For example, a receiver device ID value may indicate a value corresponding to the second electronic device 202.

According to an embodiment, the second message 1010 may include information on a minimum Wi-Fi class required when the second electronic device 202 performs scanning. For example, a required Wi-Fi class value may be information designating a minimum Wi-Fi class required when channel scanning is performed. For example, the value may be 0 if the Wi-Fi class does not matter, and the value may be 5 if Wi-Fi class 5 is utilized.

According to an embodiment, the third message 1020 may be a message transmitted by the second electronic device 202 to the first electronic device 201. The third message 1020 may be a message including information on whether to be able to perform channel scanning. As illustrated in FIG. 10, the third message 1020 may be a SERVICE_INFO_ADV_RSP message. The third message 1020 may include, for example, a status field, a transmitter device ID field, a receiver device ID field, and an available Wi-Fi class field. The status field may include information relating to whether the second electronic device 202 is to participate in a channel scan operation, the transmitter device ID field may include ID information of a transmission device, the receiver device ID field may include ID information of a reception device, and the available Wi-Fi class field may include information on a Wi-Fi class supported when the second electronic device 202 performs scanning.

According to an embodiment, the third message 1020 may include information relating to whether the second electronic device 202 is to participate in a channel scan operation. For example, if a status value is 0, this may indicate state information indicating that the second electronic device 202 is able to support scanning to be performed. The information may include a case where the second electronic device 202 is able to support scanning by changing a Wi-Fi class. If the status value is 0, this may indicate ‘Scan Accept’. For example, if the status value is 1, this may indicate state information indicating that the second electronic device 202 is unable to support scanning to be performed. The information may include a case where the second electronic device 202 is unable to support ‘Scan’ because the second electronic device 202 is providing a Wi-Fi service (is busy). If the status value is 1, this may indicate ‘Scan reject’.

According to an embodiment, the third message 1020 may include ID information of a transmission device. For example, a transmitter device ID value may include an ID value of the second electronic device 202.

According to an embodiment, the third message 1020 may include ID information of a reception device. For example, a receiver device ID value may include an ID value of the first electronic device 201.

According to an embodiment, the third message 1020 may include information on a Wi-Fi class supported when the second electronic device 202 performs scanning. For example, an available Wi-Fi class value may be information designating information on a Wi-Fi class supported when channel scanning is performed. For example, the value may be 0 if all Wi-Fi classes are supported, and the value may be 5 if Wi-Fi class 5 is supported.

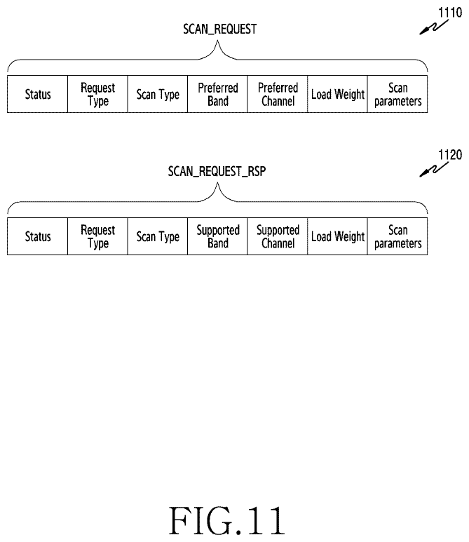

FIG. 11 is a diagram illustrating example formats of fourth and fifth messages 1110 and 1120 according to an embodiment of the disclosure.

Referring to FIG. 11, according to an embodiment, the fourth message 1110 may be a message transmitted by the first electronic device 201 to the second electronic device 202. The fourth message 1110 may include information relating to a condition requested by the first electronic device 201 when the second electronic device 202 scans for a channel. In FIG. 11, the fourth message 1110 may be a SCAN_REQUEST message. The fourth message 1110 may include, for example, a status field, a request type field, a scan type field, a preferred band field, a preferred channel field, a load weight field, and a scan parameter field. The status field may include information relating to whether there is a negotiation between the first electronic device 201 and the second electronic device 202 at the time of channel scanning. The request type field may include information on a method of transmitting the fourth message 1110, and the scan type field may include information relating to whether to scan all channels or a preferred channel. The preferred band field may include information on a band preferred by the first electronic device 201, and the preferred channel field may include information on a channel preferred by the first electronic device 201. The load weight field may include weight information utilized for channel score calculation, and the scan parameter field may include a parameter value for performing channel scanning.

According to an embodiment, the fourth message 1110 may include information relating to whether there is a negotiation between the first electronic device 201 and the second electronic device 202 at the time of channel scanning. For example, if a status value is 0, the status value may include information that requests the second electronic device 202 to perform channel scanning and indicates that a channel scan condition is negotiable. If the status value is 0, this may indicate ‘Scan Request’. For example, if the status value is 1, the status value may include information that requests the second electronic device 202 to perform channel scanning and indicates that there will be no negotiation of a channel scan condition. If the status value is 1, this may indicate ‘Scan Request without negotiation’.

According to an embodiment, the fourth message 1110 may include information on a method of transmitting the fourth message. For example, a request type value may indicate a method of transmitting the fourth message 1110. For example, the request type value may be 0 in a case of a BLE method, may be 1 in a case of a cloud method, and may be 2 in a case of a Wi-Fi method.

According to an embodiment, the fourth message 1110 may include information relating to whether to scan all channels or a preferred channel. For example, a scan type value may indicate whether to scan all channels or a preferred channel. For example, the scan type value may be 0 for full scanning, 1 for preferred band scanning, and 2 for preferred channel scanning.

According to an embodiment, the fourth message 1110 may include information on a band preferred by the first electronic device 201. For example, a preferred band value may indicate information on a band preferred by the first electronic device 201. For example, the preferred band value may be 0 when the preferred band is 2.4 GHz, 1 when the preferred band is 5 GHz, 2 when the preferred bands are 2.4 GHz and 5 GHz, 3 when the preferred band is 6 GHz, and 4 when the preferred band is 60 GHz.

According to an embodiment, the fourth message 1110 may include information on a channel preferred by the first electronic device 201. For example, a preferred channel value may indicate information on a channel preferred by the first electronic device 201. For example, the preferred channel value may be 6, 11, 36, etc. according to the preferred channel.

According to an embodiment, the fourth message 1110 may include weight information utilized for channel score calculation. For example, a load weight value may indicate a BSS load weight value. An estimation weight value may be determined according to the BSS load weight value. For example, the estimation weight value may be 1-100 according to the BSS load weight value.

According to an embodiment, the fourth message 1110 may include a parameter value for performing channel scanning. For example, a scan parameter value may be a parameter value for performing MLME-SCAN.request.

According to an embodiment, the fifth message 1120 may be a message transmitted by the second electronic device 202 to the first electronic device 201. The fifth message 1120 may include information relating to whether the second electronic device 202 is to accept a condition requested by the first electronic device 201 at the time of channel scanning. As illustrated in FIG. 11, the fifth message 1120 may be a SCAN_REQUEST_RSP message. The fifth message 1120 may include, for example, a status field, a request type field, a scan type field, a supported band field, a supported channel field, a load weight field, and a scan parameter field. The status field may include information relating to whether an electronic device that is to perform channel scanning is to accept a condition included in the fourth message. The request type field may include information on a method of transmitting the fourth message, and the scan type field may include information relating to whether to scan all channels or a preferred channel. The supported band field may include information on a band supported by the second electronic device 202, and the supported channel field may include information on a channel supported by the second electronic device 202. The load weight field may include weight information utilized for channel score calculation, and the scan parameter field may include a parameter value for performing channel scanning.

According to an embodiment, the fifth message 1120 may include information relating to whether an electronic device that is to perform channel scanning is to accept a condition included in the fourth message 1110. For example, if a status value is 0, the status value may include information indicating that the electronic device will perform channel scanning according to a condition proposed by the first electronic device 201. If the status value is 0, this may indicate ‘Accept’. For example, if the status value is 1, the status value may include information indicating that the electronic device is unable to perform channel scanning according to a condition proposed by the first electronic device 201. If the status value is 1, this may indicate ‘Reject’.

According to an embodiment, the fifth message 1120 may include information on a method of transmitting the fourth message 1110. For example, a request type value may indicate a method of transmitting the fourth message 1110. For example, the request type value may be 0 in a case of a BLE method, 1 in a case of a cloud method, and 2 in a case of a Wi-Fi method.

According to an embodiment, the fifth message 1120 may include information relating to whether to scan all channels or a preferred channel. For example, a scan type value may indicate whether to scan all channels or a preferred channel. For example, the scan type value may be 0 for full scanning, 1 for preferred band scanning, and 2 for preferred channel scanning.

According to an embodiment, the fifth message 1120 may include information on a band supported by the second electronic device 202. For example, a supported band value may indicate information on a band supported by the second electronic device 202. For example, the supported band value may be 0 when the supported band is 2.4 GHz, 1 when the supported band is 5 GHz, 2 when the supported bands are 2.4 GHz and 5 GHz, 3 when the supported band is 6 GHz, and 4 when the supported band is 60 GHz.

According to an embodiment, the fifth message 1120 may include information on a channel supported by the second electronic device 202. For example, a supported channel value may indicate information on a channel supported by the second electronic device 202. For example, the supported channel value may be 6, 11, 36, etc. according to the supported channel.

According to an embodiment, the fifth message 1120 may include weight information utilized for channel score calculation. For example, a load weight value may indicate a BSS load weight value. An estimation weight value may be determined according to the BSS load weight value. For example, the estimation weight value may be 1-100 according to the BSS load weight value.

According to an embodiment, the fifth message 1120 may include a parameter value for performing channel scanning. For example, a scan parameter value may be a parameter value for performing MLME-SCAN.request.

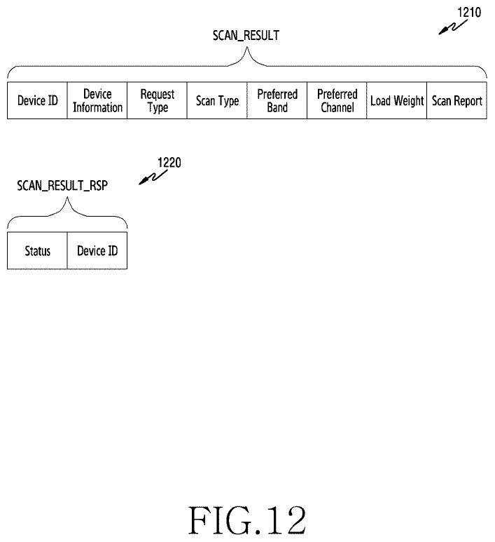

FIG. 12 illustrates example formats of sixth and response messages 1210 and 1220 according to an embodiment of the disclosure.

According to an embodiment, the sixth message 1210 may be a message transmitted by the second electronic device 202 to the first electronic device 201. The sixth message 1210 may include information on a result of scanning for a channel by the second electronic device 202. As illustrated in FIG. 12, the sixth message 1210 may be a SCAN_RESULT message. The sixth message 1210 may include, for example, a device ID field, a device information field, a request type field, a scan type field, a preferred band field, a preferred channel field, a load weight field, and a scan report field. The device ID field may include ID information of a scan device, and the device information field may include feature information of a scan device. The request type field may include information on a method of transmitting the fourth message, and the scan type field may include information relating to whether to scan all channels or a preferred channel. The preferred band field may include information on a band preferred by the first electronic device 201, and the preferred channel field may include information on a channel preferred by the first electronic device 201. The load weight field may include weight information utilized for channel score calculation, and the scan report field may include scan report information including a channel score.

According to an embodiment, the sixth message 1210 may include ID information of a scan device. For example, a device ID value may indicate a value corresponding to the second electronic device 202.

According to an embodiment, the sixth message 1210 may include feature information of a scan device. For example, a device information value may indicate feature information of the second electronic device 202. For example, the device information value may indicate a Wi-Fi version, the number of antennas, etc. of the second electronic device 202.

According to an embodiment, the sixth message 1210 may include information on a method of transmitting the fourth message (e.g., the fourth message 1110 of FIG. 11). For example, a request type value may indicate a method of transmitting the fourth message. For example, the request type value may be 0 in a case of a BLE method, 1 in a case of a cloud method, and 2 in a case of a Wi-Fi method.

According to an embodiment, the sixth message 1210 may include information relating to whether to scan all channels or a preferred channel. For example, a scan type value may indicate whether to scan all channels or a preferred channel. For example, the scan type value may be 0 for full scanning, 1 for preferred band scanning, and 2 for preferred channel scanning.

According to an embodiment, the sixth message 1210 may include information on a band preferred by the first electronic device 201. For example, a preferred band value may indicate information on a band preferred by the first electronic device 201. For example, the preferred band value may be 0 when the preferred band is 2.4 GHz, 1 when the preferred band is 5 GHz, 2 when the preferred bands are 2.4 GHz and 5 GHz, 3 when the preferred band is 6 GHz, and 4 when the preferred band is 60 GHz.

According to an embodiment, the sixth message 1210 may include information on a channel preferred by the first electronic device 201. For example, a preferred channel value may indicate information on a channel preferred by the first electronic device 201. For example, the preferred channel value may be 6, 11, 36, etc. according to the preferred channel.

According to an embodiment, the sixth message 1210 may include weight information utilized for channel score calculation. For example, a load weight value may indicate a BSS load weight value. An estimation weight value may be determined according to the BSS load weight value. For example, the estimation weight value may be 1-100 according to the BSS load weight value.

According to an embodiment, the sixth message 1210 may include scan report information including a channel score. For example, a scan report value may include a channel score value calculated by the second electronic device 202. The scan report value may also include a MLME-SCAN.confirm result value. For example, if there is an empty channel, the scan report value may include information on the empty channel.

According to an embodiment, the first electronic device 201 may, in response to the sixth message, may transmit, to the second electronic device 202, a response message 1220 for a scan result, which indicates that a channel scan result of the second electronic device 202 has been received. As illustrated in FIG. 12, the response message 1220 for the scan result may be a SCAN_RESULT_RSP message. The SCAN_RESULT_RSP message 1220 may include, for example, a status field and a device ID field.

According to an embodiment, the scan result response message 1220 may include information relating to whether the sixth message has been received. For example, a status value in the scan result response message 1220 may indicate whether the sixth message 1210 has been received. For example, the status value may indicate information relating to whether the first electronic device 201 has received the SCAN_RESULT message 1210.

According to an embodiment, the scan result response message 1220 may include ID information of a scan device. For example, a device ID value in the scan result response message 1220 may indicate a value corresponding to the second electronic device 202.

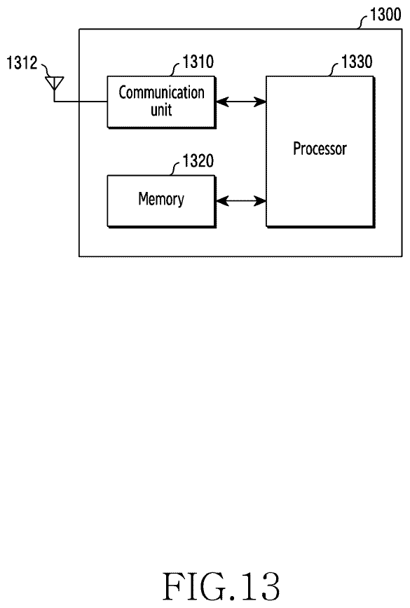

FIG. 13 is a block diagram illustrating a configuration of a first electronic device 1300 according to an embodiment of the disclosure.

The first electronic device 1300 (e.g., the electronic device 101 in FIG. 1 or the first electronic device 201 in FIG. 2) according to an embodiment of the disclosure may include a communication circuit 1310, an antenna module 1312, memory 1320, and a processor 1330. However, the configuration of the first electronic device 1300 is not limited thereto, and may include only some of the above elements of FIG. 13 or may further include at least another element (e.g., modules in FIG. 1) other than the above elements. Accordingly, the communication circuit 1310 may correspond to the communication module 190 or the wireless communication module 192 in FIG. 1, and the antenna module 1312 may correspond to the antenna module 197 in FIG. 1. In addition, the memory 1320 and the processor 1330 may correspond to the memory 130 and the processor 120 in FIG. 1, and if the first electronic device 1300 further includes another element, the other element may also correspond to an element in FIG. 1.

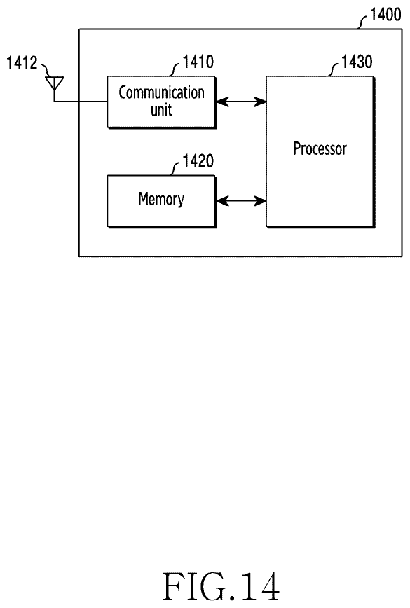

The communication circuit 1310 may support wireless communication between the first electronic device 1300 and a second electronic device (e.g., the second electronic device 1400 of FIG. 14). For example, the communication circuit 1310 may transmit and receive control information and/or data to and from at least one second electronic device 1400 by using a frequency band supported by wireless communication according to a defined wireless communication protocol. In an embodiment, the communication circuit 1310 may include a Bluetooth module for Bluetooth legacy communication and/or BLE communication as a wireless communication module. The first electronic device 1300 may establish a Bluetooth connection with the second electronic device 1400 and transmit and receive control information and/or data by using the Bluetooth module. In an embodiment, the communication circuit 1310 may include a Wi-Fi module for WLAN communication as a wireless communication module. The first electronic device 1300 may establish a WLAN connection with the second electronic device 1400 and transmit and receive control information and/or data by using the Wi-Fi module.

The communication circuit 1310 may be operated independently of the processor 1330 and include one or more communication processors supporting wireless communication. In an embodiment, the communication circuit 1310 may be called a communication interface or a communication module.

The antenna module 1312 may include multiple antennas. At least one antenna suitable for a communication method used in a communication network (e.g., the first network 198 in FIG. 1) may be selected from among the multiple antennas by the communication circuit 1310.

The memory 1320 may store various information for an operation of the first electronic device 1300. The information stored in the memory 1320 may include, for example, software and input data or output data related to a command related thereto. In an embodiment, the information stored in the memory 1320 may include at least one instruction for an operation of the first electronic device 1300. The instruction may correspond to the program 140 of FIG. 1. The instruction stored in the memory 1320 may be executed through the processor 1330. Instructions may be executed by the processor 1330, whereby the first electronic device 1300 may perform operations according to an embodiment of the disclosure. The memory 1320 may include a volatile memory or a non-volatile memory.

The processor 1330 may control at least a different element (e.g., a hardware or software element) of the first electronic device 1300, and perform various data processing or computation. As at least a part of data processing or computation, the processor 1330 may load, in the memory 1320, a command or data received from a different element (e.g., the communication circuit 1310), process the command or data stored in the memory 1320, and store resultant data in the memory 1320. In an embodiment, the processor 1330 may execute at least one instruction, stored in the memory 1320, for an operation of the first electronic device 1300.

In an embodiment, the processor 1330 may be configured to execute the instruction stored in the memory 1320 to cause the first electronic device 1300 to receive, from an audio output device performing a wireless audio service by being connected to the first electronic device 1300, a first message including information on a connection state of a channel between the first electronic device 1300 and the audio output device, search for the second electronic device 1400 around the first electronic device 1300, based on the information on the connection state of the channel between the first electronic device 1300 and the audio output device, request the second electronic device 1400 to perform channel scanning, obtain a channel estimation result based on a result of scanning by the second electronic device 1400, and change the channel between the first electronic device 1300 and the audio output device, based on the channel estimation result.

In an embodiment, the searching for the second electronic device 1400 by the first electronic device 1300 may be configured to include broadcasting a second message including information related to a channel scan request through a BLE advertising packet, establishing a wireless connection with the second electronic device, based on the BLE advertising packet, and receiving, from the second electronic device 1400, a third message including information relating to whether the second electronic device is able to perform the channel scanning.

In an embodiment, the second message may include at least one of information on a Wi-Fi class utilized for the channel scanning or information relating to whether there is a negotiation between the first electronic device 1300 and the second electronic device 1400 at the time of performing the channel scanning, and the third message may include at least one of information on a Wi-Fi class supported by the second electronic device 1400 or information relating to whether the second electronic device 1400 performs the channel scanning.

In an embodiment, in case that the first electronic device 1300 has failed to establish a wireless connection with the second electronic device 1400, the processor 1330 may be configured to execute the instruction stored in the memory 1320 to transmit, to a server, a request to search for an electronic device positioned around the first electronic device 1300 and linked to an account identical to that of the first electronic device 1300, in case that the second electronic device 1400 exists, transmit the second message to the second electronic device 1400, and receive the third message from the second electronic device 1400.

In an embodiment, the requesting of, by the first electronic device 1300, the second electronic device 1400 to perform channel scanning may be configured to include transmitting, to the second electronic device 1400, a fourth message including at least one of information on a channel preferred by the first electronic device 1300, information on a band preferred by the first electronic device 1300, weight information utilized for channel score calculation, or information relating to whether there is a negotiation between the first electronic device 1300 and the second electronic device 1400 at the time of the channel scanning, and in response to the fourth message, receiving, from the second electronic device 1400, a fifth message including at least one of information on a band supported by the second electronic device 1400, information on a channel supported by the second electronic device 1400, or information indicating whether to accept a condition requested by the first electronic device 1300.

In an embodiment, the obtaining of the channel estimation result by the first electronic device 1300 may be configured to include receiving, from the second electronic device 1400, a sixth message including at least one of a channel score obtained by the second electronic device 1400, based on a result of the channel scanning or feature information of the second electronic device 1400, and the channel score may be calculated based on the weight information by using information received by the second electronic device 1400 from an access point (AP) at the time of channel scanning.

In an embodiment, the weight information may include a basic service set (BSS) load weight and an estimation weight. The channel score may be calculated by applying the load weight to BSS load information received by the second electronic device 1400 from the AP at the time of channel scanning and applying the estimation weight to at least one of response time information indicating a time interval between a probe request message transmitted by the second electronic device 1400 to the AP and a probe response message transmitted by the AP to the second electronic device 1400 in response to the probe request message, information on a response rate of the probe response message to the probe request message repeatedly transmitted by the second electronic device 1400 for a predetermined time, or radio measurement result information. The BSS load information may include at least one of channel utilization information indicating a congestion level of a channel, station count information indicating the number of clients connected to a channel, or available admission capacity information indicating an admissible capacity of a channel.

In an embodiment, the changing of, by the first electronic device 1300, the channel between the first electronic device 1300 and the audio output device may be configured to include selecting an optimal channel, based on the channel score and the feature information of the second electronic device 1400 received from the second electronic device 1400, and connecting to the audio output device through the selected optimal channel.

In an embodiment, the processor 1330 may be configured to execute the instruction stored in the memory 1320 to receive, from a third electronic device around the first electronic device 1300, a seventh message including at least one of a channel score obtained by the third electronic device or feature information of the third electronic device, and select the optimal channel, based on at least one of the channel score obtained by the second electronic device 1400, the feature information of the second electronic device 1400, the channel score obtained by the third electronic device, or the feature information of the third electronic device.

FIG. 14 is a block diagram briefly illustrating a configuration of a second electronic device 1400 according to an embodiment of the disclosure.

The second electronic device 1400 (e.g., the electronic device 102 in FIG. 1 or the second electronic device 502 in FIG. 5) according to an embodiment of the disclosure may include a communication circuit 1410, an antenna module 1412, memory 1420, and a processor 1430. However, the configuration of the second electronic device 1400 is not limited thereto, and may include only some of the above elements of FIG. 14 or may further include at least another element other than the above elements.

The communication circuit 1410 may support wireless communication between the second electronic device 1400 and a first electronic device (e.g., the first electronic device 1300 of FIG. 13). For example, the communication circuit 1410 may transmit and receive control information and/or data to and from at least one first electronic device 1300 by using a frequency band supported by wireless communication according to a defined wireless communication protocol. In an embodiment, the communication circuit 1410 may include a Bluetooth module 1411 for Bluetooth legacy communication and/or BLE communication as a wireless communication module. The second electronic device 1400 may establish a Bluetooth connection with the first electronic device 1300 and transmit and receive control information and/or data by using the Bluetooth module. In an embodiment, the communication circuit 1410 may include a Wi-Fi module for WLAN communication as a wireless communication module. The second electronic device 1400 may establish a WLAN connection with the first electronic device 1300 and transmit and receive control information and/or data by using the Wi-Fi module.

The communication circuit 1410 may be operated independently of the processor 1430 and include one or more communication processors supporting wireless communication. In an embodiment, the communication circuit 1410 may be called a communication interface or a communication module.

The antenna module 1412 may include multiple antennas. At least one antenna suitable for a communication method used in a communication network (e.g., the first network 198 in FIG. 1) may be selected from among the multiple antennas by the communication circuit 1410.

The memory 1420 may store various information for an operation of the second electronic device 1400. The information stored in the memory 1420 may include, for example, software and input data or output data related to a command related thereto. In an embodiment, the information stored in the memory 1420 may include at least one instruction for an operation of the second electronic device 1400. The instruction may include a program. The instruction stored in the memory 1420 may be executed through the processor 1430. Instructions may be executed by the processor 1430, whereby the second electronic device 1400 may perform operations according to an embodiment of the disclosure. The memory 1420 may include a volatile memory or a non-volatile memory.

The processor 1430 may control at least a different element (e.g., a hardware or software element) of the second electronic device 1400, and perform various data processing or computation. As at least a part of data processing or computation, the processor 1430 may load, in the memory 1420, a command or data received from a different element (e.g., the communication circuit 1410), process the command or data stored in the memory 1420, and store resultant data in the memory 1420. In an embodiment, the processor 1430 may execute at least one instruction, stored in the memory 1420, for an operation of the second electronic device 1400.

In an embodiment, the processor 1430 may be configured to execute the instruction stored in the memory 1430 to cause the second electronic device 1400 to establish a connection with the first electronic device 1300 searching for a surrounding electronic device, negotiate a channel scan condition with the first electronic device 1300, perform channel scanning, calculate a channel score, based on a scan result, and transmit the channel score to the first electronic device 1300.

In an embodiment, the establishing of the connection with the first electronic device 1300 by the second electronic device 1400 may include receiving, from the first electronic device 1300, a second message including information related to a channel scan request through a BLE advertising packet, establishing a wireless connection with the first electronic device 1300, based on the BLE advertising packet, and transmitting, to the first electronic device 1300, a third message including information relating to whether to able to perform channel scanning.

In an embodiment, the second message may include at least one of information on a Wi-Fi class utilized for the channel scanning or information relating to whether there is a negotiation between the first electronic device 1300 and the second electronic device 1400 at the time of the channel scanning, and the third message may include at least one of information on a Wi-Fi class supported by the second electronic device or information relating to whether the second electronic device performs the channel scanning.

In an embodiment, the negotiating of the channel scan condition by the second electronic device 1400 may include receiving, from the first electronic device 1300, a fourth message including at least one of information on a channel preferred by the first electronic device 1300, information on a band preferred by the first electronic device 1300, weight information utilized for channel score calculation, or information relating to whether there is a negotiation between the first electronic device 1300 and the second electronic device 1400 at the time of the channel scanning, and in response to the fourth message, transmitting, to the first electronic device 1300, a fifth message including at least one of information on a band supported by the second electronic device 1400, information on a channel supported by the second electronic device 1400, or information indicating whether the second electronic device 1400 is to perform the channel scanning.

In an embodiment, the performing of the channel scanning by the second electronic device 1400 may include performing a radio measurement to obtain radio measurement result information, scanning for an empty channel, based on the radio measurement result information, in case that the empty channel is discovered, calculating a score of the empty channel, and in case that the empty channel does not exist, scanning for a channel.

In an embodiment, the weight information may include a BSS load weight and an estimation weight. The channel score may be calculated by applying the load weight to BSS load information received from an AP at the time of channel scanning and applying the estimation weight to at least one of response time information indicating a time interval between a probe request message transmitted to the AP and a probe response message received from the AP in response to the probe request message, information on a response rate of the probe response message to the probe request message repeatedly transmitted for a predetermined time, or the radio measurement result information. The BSS load information may include at least one of channel utilization information indicating a congestion level of a channel, station count information indicating the number of clients connected to a channel, or available admission capacity information indicating an admissible capacity of a channel.

In an embodiment, the transmitting of the channel score to the first electronic device 1300 by the second electronic device 1400 may include transmitting, to the first electronic device 1300, a sixth message including at least one of the calculated channel score or feature information of the second electronic device 1400.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

In this disclosure, the functions or operations performed by an electronic device may be performed by one or more processors by executing one or more instructions stored in memory. The functions or operations of an electronic device mentioned in the disclosure may be performed by a single processor by executing one or more instructions, or may be performed by a combination of multiple processors by executing one or more instructions. The processors referred to in the disclosure are understood to include a circuit for performing computation or controlling other elements of the electronic device. For example, the one or more processors may include a central processing unit (CPU), a microprocessor unit (MPU), an application processor (AP), a communication processor (CP), a neural processing unit (NPU), a system on chip (SoC), or an integrated circuit (IC), which are configured to execute one or more instructions. The one or more processors may be configured to perform operations of the electronic device described above.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. The memory may include a single storage medium or a combination of multiple storage media. The above one or more instructions may be stored in a single storage medium or distributedly stored in multiple storage media.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

In the disclosure, the term “unit” or “module” may refer to a hardware component such as a processor or circuit, and/or a software component executed by a hardware component such as a processor.

The “unit” or “module” may be stored in an addressable storage medium and may be implemented by a program executable by a processor. For example, the “unit” or “module” may be implemented by elements such as software elements, object-oriented software elements, class elements, and task elements, processes, functions, attributes, procedures, sub-routines, segments of program codes, drivers, firmware, micro-codes, circuits, data, databases, data structures, tables, arrays, and parameters.

Specific executions described in the disclosure are merely embodiments, and are not intended to limit the scope of the disclosure in any way. For brevity of the specification, descriptions of conventional electronic configurations, control systems, software, and other functional aspects of such systems may be omitted.

Additionally, in the disclosure, “includes at least one of a, b, or c” may indicate including only a, including only b, including only c, or including a combination of two or more (including a and b, including b and c, including a and c, or including all of a, b, and c).

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a first electronic device, the method comprising:
receiving, from an audio output device configured to perform a wireless audio service and connected to the first electronic device, a first message including information on a connection state of a channel between the first electronic device and the audio output device;
searching for a second electronic device around the first electronic device based on the information on the connection state of the channel between the first electronic device and the audio output device;
requesting the second electronic device to perform channel scanning;
obtaining a channel estimation result based on a result of scanning by the second electronic device; and
changing the channel between the first electronic device and the audio output device based on the channel estimation result.

2. The method of claim 1, wherein searching for the second electronic device comprises:
broadcasting a second message including information related to a channel scan request through a bluetooth low energy (BLE) advertising packet;
establishing a wireless connection with the second electronic device based on the BLE advertising packet; and
receiving, from the second electronic device, a third message including information relating to whether the second electronic device is able to perform the channel scanning.

3. The method of claim 2, wherein the second message comprises at least one of information on a Wi-Fi class utilized for the channel scanning or information relating to whether there is a negotiation between the first electronic device and the second electronic device at a time of performing the channel scanning, and
wherein the third message comprises at least one of information on a Wi-Fi class supported by the second electronic device or information relating to whether the second electronic device performs the channel scanning.

4. The method of claim 2, further comprising, in case that establishing of a wireless connection with the second electronic device has failed:
transmitting, to a server, a request to search for an electronic device positioned around the first electronic device and linked to an account identical to that of the first electronic device;
in case that the second electronic device exists, transmitting the second message to the second electronic device; and
receiving the third message from the second electronic device.

5. The method of claim 1, wherein requesting the second electronic device to perform channel scanning comprises:
transmitting, to the second electronic device, a fourth message including at least one of information on a channel preferred by the first electronic device, information on a band preferred by the first electronic device, weight information utilized for channel score calculation, or information relating to whether there is a negotiation between the first electronic device and the second electronic device at a time of the channel scanning; and
in response to the fourth message, receiving, from the second electronic device, a fifth message including at least one of information on a band supported by the second electronic device, information on a channel supported by the second electronic device, or information indicating whether to accept a condition requested by the first electronic device.

6. The method of claim 5, wherein obtaining the channel estimation result comprises receiving, from the second electronic device, a sixth message including at least one of a channel score obtained by the second electronic device, based on a result of the channel scanning or feature information of the second electronic device, and
wherein the channel score is calculated based on the weight information by using information received by the second electronic device from an access point (AP) at a time of channel scanning.

7. The method of claim 6, wherein the weight information comprises a basic service set (BSS) load weight and an estimation weight,
wherein the channel score is calculated by applying the load weight to BSS load information received by the second electronic device from the AP at a time of channel scanning and applying the estimation weight to at least one of response time information indicating a time interval between a probe request message transmitted by the second electronic device to the AP and a probe response message transmitted by the AP to the second electronic device in response to the probe request message, information on a response rate of the probe response message to the probe request message repeatedly transmitted by the second electronic device for a predetermined time, or radio measurement result information, and
wherein the BSS load information comprises at least one of channel utilization information indicating a congestion level of a channel, station count information indicating a number of clients connected to a channel, or available admission capacity information indicating an admissible capacity of a channel.

8. The method of claim 6, further comprising:
transmitting, to the second electronic device, a response message based on the sixth message, the response message including a value corresponding to the second electronic device.

9. The method of claim 6, wherein changing the channel between the first electronic device and the audio output device comprises:
selecting an optimal channel, based on the channel score and the feature information of the second electronic device received from the second electronic device; and
connecting to the audio output device through the selected optimal channel.

10. The method of claim 9, further comprising:
receiving, from a third electronic device around the first electronic device, a seventh message including at least one of a channel score obtained by the third electronic device or feature information of the third electronic device; and
selecting the optimal channel, based on at least one of the channel score obtained by the second electronic device, the feature information of the second electronic device, the channel score obtained by the third electronic device, or the feature information of the third electronic device.

11. A method of a second electronic device, the method comprising:
establishing a connection with a first electronic device searching for a surrounding electronic device;
negotiating a channel scan condition with the first electronic device;
performing channel scanning;
calculating a channel score based on a scan result; and
transmitting the channel score to the first electronic device.

12. The method of claim 11, wherein establishing the connection with the first electronic device comprises:
receiving, from the first electronic device, a second message including information related to a channel scan request through a bluetooth low energy (BLE) advertising packet;
establishing a wireless connection with the first electronic device, based on the BLE advertising packet; and
transmitting, to the first electronic device, a third message including information relating to whether the second electronic device is able to perform channel scanning.

13. The method of claim 12, wherein the second message comprises at least one of information on a Wi-Fi class utilized for the channel scanning or information relating to whether there is a negotiation between the first electronic device and the second electronic device at a time of the channel scanning, and
wherein the third message comprises at least one of information on a Wi-Fi class supported by the second electronic device or information relating to whether the second electronic device performs the channel scanning.

14. The method of claim 11, wherein negotiating the channel scan condition comprises:
receiving, from the first electronic device, a fourth message including at least one of information on a channel preferred by the first electronic device, information on a band preferred by the first electronic device, weight information utilized for channel score calculation, or information relating to whether there is a negotiation between the first electronic device and the second electronic device at a time of the channel scanning; and
in response to the fourth message, transmitting, to the first electronic device, a fifth message including at least one of information on a band supported by the second electronic device, information on a channel supported by the second electronic device, or information indicating whether the second electronic device is to perform the channel scanning.

15. The method of claim 14, wherein performing the channel scanning comprises:
performing a radio measurement to obtain radio measurement result information;
scanning for an empty channel, based on the radio measurement result information;
in case that the empty channel is discovered, calculating a score of the empty channel; and
in case that the empty channel does not exist, scanning for a channel.

16. The method of claim 15, wherein the weight information comprises a basic service set (BSS) load weight and an estimation weight,
wherein the channel score is calculated by applying the load weight to BSS load information received from an AP at a time of channel scanning and applying the estimation weight to at least one of response time information indicating a time interval between a probe request message transmitted to the AP and a probe response message received from the AP in response to the probe request message, information on a response rate of the probe response message to the probe request message repeatedly transmitted for a predetermined time, or the radio measurement result information, and
wherein the BSS load information comprises at least one of channel utilization information indicating a congestion level of a channel, station count information indicating a number of clients connected to a channel, or available admission capacity information indicating an admissible capacity of a channel.

17. The method of claim 16, wherein transmitting the channel score to the first electronic device comprises transmitting, to the first electronic device, a sixth message including at least one of the calculated channel score or feature information of the second electronic device.

18. The method of claim 17, further comprising:
receiving, from the first electronic device, a response message based on the sixth message, the response message including a value corresponding to the second electronic device.

19. A first electronic device comprising:
a communication circuit comprising an antenna;
a memory configured to store instructions; and
at least one processor,
wherein the instructions are executed by the at least one processor to cause the first electronic device to:
receive, from an audio output device configured to perform a wireless audio service and connected to the first electronic device, a first message including information on a connection state of a channel between the first electronic device and the audio output device;
search for a second electronic device around the first electronic device based on the information on the connection state of the channel between the first electronic device and the audio output device;
request the second electronic device to perform channel scanning;
obtain a channel estimation result based on a result of scanning by the second electronic device; and
change the channel between the first electronic device and the audio output device based on the channel estimation result.

20. A second electronic device comprising:
a communication circuit comprising an antenna;
a memory configured to store instructions; and
at least one processor,
wherein the instructions are executed by the at least one processor to cause the second electronic device to:
establish a connection with a first electronic device searching for a surrounding electronic device;
negotiate a channel scan condition with the first electronic device;
perform channel scanning;
calculate a channel score based on a scan result; and
transmit the channel score to the first electronic device.
